(19) United States
(12) Patent Application Publication
(10) Pub. No.: US 2024/0243355 A1
(43) Pub. Date: Jul. 18, 2024

(54) SOLID POLYMER ELECTROLYTE WITH ELASTIC PROPERTIES AND MANUFACTURING METHOD THEREOF

(71) Applicant: Nuvvon, Inc., Bordentown, NJ (US)

(72) Inventor: Manveer S. Sidhu, Levittown, PA (US)

(21) Appl. No.: 18/414,127

(22) Filed: Jan. 16, 2024

Related U.S. Application Data
(60) Provisional application No. 63/480,472, filed on Jan. 18, 2023.

(51) Int. Cl. H01M 10/0565; H01M 4/04; H01M 4/136; H01M 4/1397; H01M 4/62; H01M 10/0585; H01M 50/403; H01M 50/426; H01M 50/46; H01M 50/497

(52) U.S. Cl. CPC H01M 10/0565; H01M 4/0404; H01M 4/0435; H01M 4/136; H01M 4/1397; H01M 4/62; H01M 10/0585; H01M 50/403; H01M 50/426; H01M 50/46; H01M 50/497; H01M 2004/028; H01M 2300/0082

(57) ABSTRACT

A polymer electrolyte including a polyvinylidene fluoride (PVDF), a lithium salt, and a cyanoethyl polyvinyl alcohol (CN-PVA). In various embodiments, the PVDF may be a PVDF (534K) or a PVDF (700K). In the various embodiments, the lithium salt may be a lithium bis(trifluoromethanesulfonyl)imide (LiTFSI). The polymer electrolyte, comprising the PVDF, the lithium salt, and the CN-PVA, is formed into a free-standing membrane that has an ionic conductivity greater than 1×10⁻⁵ S/cm at a temperature greater than or equal to 25° C. The polymer electrolyte functions as a catholyte in a composite cathode with a cathode active material. In another aspect, the polymer electrolyte is formed as a polymer electrolyte separator on the composite cathode; the composite cathode and the polymer electrolyte separator useable in a rechargeable battery cell. And yet in other aspects, methods for manufacturing the polymer electrolyte, the composite cathode, and the polymer electrolyte separator.

### CROSS REFERENCE TO RELATED APPLICATION

This application claims priority under 35 U.S.C. § 119(e) to U.S. Provisional Patent Application No. 63/480,472 filed on Jan. 18, 2023, which is incorporated by reference herein in its entirety.

### BACKGROUND

The present disclosure relates to the field of electrochemical cells, including electrolyte materials, electrodes, and other components used in electrochemical cells.

Solid state lithium-ion batteries (“solid state batteries”) use a solid electrolyte as opposed to a liquid electrolyte. Solid state batteries have higher energy density than comparable lithium-ion batteries built with a liquid electrolyte. Solid state batteries are also intrinsically safer than lithium-ion batteries that utilize liquid electrolytes because solid state electrolytes are not as flammable as liquid electrolytes. Polymers are highly suited to fabricating solid state electrolytes due to their low flammability, processability, flexibility, structural stability, thermal stability, and wide electrochemical stability window. The present disclosure relates to solid polymer electrolytes (SPEs) and their application to lithium-ion batteries.

Conventional SPEs utilize a polymer known as polyethylene oxide (PEO), which are sometimes addressed as polyethylene glycol (PEG) at lower molecular weights. While a PEO can complex with numerous lithium salts, it suffers from poor ionic conductivity at room temperature (10⁻⁶ S/cm) due to its semicrystalline nature, which blocks efficient transport of the lithium cations. There was therefore a need to develop a polymer that after formulation into a SPE, would have better ionic conductivity. SPEs formulated using other polymers such as polyacrylonitrile (PAN) and polyvinyl pyrrolidone (PVP) also suffer from poor ionic conductivity.

Conventional SPEs often also utilize a plasticizer or plasticizing agent such as ethylene carbonate (“EC”), propylene carbonate (PC), diethyl carbonate (“DEC”), or dimethyl carbonate (“DMC”). While the plasticizer greatly enhances the electrochemical performance of the SPE (i.e., improves ionic conductivity, increases the transference number, and expands the voltage window), the mechanical integrity of the SPE worsens as the plasticizer content increases.

Furthermore, conventional SPEs are also heavily reliant on lithium hexafluorophosphate (“LiPF₆”) as the primary lithium salt used. LiPF₆ is commonly used in conventional liquid electrolyte formulations. LiPF₆ can give off hydrogen fluoride when it comes into contact with water. Even small amounts of hydrogen fluoride can be harmful; exposure to highly concentrated hydrogen fluoride may be fatal. These characteristics make the handling of LiPF₆ less desirable. LiPF₆ also limits the operating temperature of the lithium-ion battery cell, particularly at high temperatures.

### SUMMARY

In one aspect of the disclosure, a polymer electrolyte is provided, the polymer electrolyte including a polyvinylidene fluoride (“PVDF”), a cyanoethyl polyvinyl alcohol (“CN-PVA”), and a lithium salt. The PVDF, the lithium salt, and the CN-PVA are formed into a free-standing membrane. In some embodiments, the PVDF is a PVDF (534K). Yet in other embodiments, the PVDF is a PVDF (700K). In the various embodiments, the polymer electrolyte has an ionic conductivity of 1×10⁻⁵ S/cm or greater at a temperature greater than or equal to 25° C. In the embodiment where the PVDF is a PVDF (534K) and the lithium salt is LiTFSI, the polymer electrolyte comprises 15 wt % to 55 wt % of the PVDF (534K), 5 wt % to 40 wt % of the CN-PVA, and 40 wt % to 70 wt % of the LiTFSI. In the embodiment where the PVDF is a PVDF (700K) and the lithium salt is LiTFSI, the polymer electrolyte comprises 15 wt % to 55 wt % of the PVDF (700K), 5 wt % to 35 wt % of the CN-PVA, and 40 wt % to 80 wt % of the LiTFSI.

Another aspect of the disclosure relates to a method of manufacturing a polymer electrolyte according to an embodiment of the present disclosure. A PVDF is dissolved in a first organic solvent. A lithium salt is dissolved in a second organic solvent. A CN-PVA is also dissolved in the second organic solvent. The second organic solvent containing the LiTFSI and the CN-PVA is added to the first organic solvent containing the PVDF to obtain a mixture that is heated and mixed until it is homogeneous.

Another aspect of the disclosure provides for a composite cathode including the various embodiments of the polymer electrolyte as described above mixed with a cathode active material, a carbon black, and a polyvinylidene difluoride binder, and formed as a cathode film on a current collector. In this aspect of the disclosure, the polymer electrolyte functions as a catholyte in the composite cathode. In one embodiment, the cathode active material can be a lithium iron phosphate.

Yet another aspect of the disclosure provides for manufacturing a composite cathode according to an embodiment of the present disclosure. A polymer electrolyte according to the various embodiments as described above is prepared. The polymer electrolyte is mixed with a cathode active material, a carbon containing material, and a polyvinylidene difluoride binder binding the cathode active material, the carbon-containing material, and the polymer electrolyte; the cathode active material, the carbon-containing material, the polyvinylidene difluoride binder, and the polymer electrolyte are then formed as a cathode film; the cathode film is then formed on a current collector. In some embodiments, the cathode film layer and the current collector are calendered to increase the density of the cathode film layer to 1.7 g/cm³.

One aspect of the disclosure also provides for a polymer electrolyte separator formed using the various embodiments of polymer electrolyte of the present disclosure. Another aspect of the disclosure also provides for a method of manufacturing the polymer electrolyte separator. A polymer electrolyte according to the various embodiments as described above is prepared. The polymer electrolyte is then cast onto the composite cathode manufactured using the method described above. The polymer electrolyte separator can also be separately formed and then integrated with the composite cathode by dry placement.

Another aspect of the disclosure is related to an electrode sub-stack that includes the composite cathode and the polymer electrolyte separator, each with various embodiments of the polymer electrolyte as described above. The electrode sub-stack also includes an anode layer formed on a negative current collector to form an anode. The anode, polymer electrolyte separator, and composite cathode together form the electrode sub-stack.

Another aspect of the present disclosure provides for a rechargeable battery cell with a composite cathode including a cathode layer formed on a first current collector, where the composite cathode is according to various embodiments of the polymer electrolyte as described above; an anode layer formed on a second current collector to form a negative electrode where the anode layer is a lithium metal; a polymer electrolyte separator according to various embodiments of the polymer electrolyte as described above, the polymer electrolyte separator separating the positive electrode and the negative electrode. The positive electrode, negative electrode, and polymer electrolyte separator are solid.

These and other aspects are described further below with reference to the figures.

### BRIEF DESCRIPTION OF THE DRAWINGS

FIG. (“Fig.”) 1 is a flow chart showing the steps of preparing a polymer electrolyte and preparing a composite cathode based on the polymer electrolyte according to an embodiment of the present disclosure.

FIG. 2A is a perspective view illustrating the preparation of a polymer electrolyte mixture according to an embodiment of the present disclosure.

FIG. 2B is a perspective view illustrating the preparation of a slurry mixture to form a composite cathode according to an embodiment of the present disclosure.

FIG. 2C is a perspective view illustrating the solution casting and doctor blading of a slurry mixture to form a composite cathode according to an embodiment of the present disclosure.

FIG. 2D is a side view illustrating the solution casting and doctor blading of a slurry mixture to form a composite cathode according to an embodiment of the present disclosure.

FIG. 2E illustrates the slurry mixture on the composite cathode after doctor blading according to an embodiment of the present disclosure.

FIG. 2F illustrates the calendering of the composite cathode according to an embodiment of the present disclosure.

FIG. 2G is a perspective view illustrating the solution casting of a polymer electrolyte separator using the polymer electrolyte according to an embodiment of the present disclosure.

FIG. 2H is a side view illustrating the doctor blading of the solution cast polymer electrolyte separator according to an embodiment of the present disclosure.

FIG. 3A illustrates a rechargeable battery cell according to an embodiment of the present disclosure.

FIG. 3B illustrates an example of a cross-sectional structure of the rechargeable battery cell according to an embodiment of the present disclosure.

FIG. 3C illustrates an example of a perspective view of the rechargeable battery cell according to an embodiment of the present disclosure.

FIG. 4A is a perspective view illustrating a polymer electrolyte according to an embodiment of the present disclosure.

FIG. 4B is a perspective view illustrating a polymer electrolyte according to an embodiment of the present disclosure.

FIG. 4C is a perspective view illustrating a polymer electrolyte according to an embodiment of the present disclosure.

FIG. 5 is chart showing the specific capacity of a cell according to an embodiment of the present disclosure discharged at 25° C.

FIG. 6 is chart showing the specific capacity of a cell according to an embodiment of the present disclosure discharged at 50° C.

### DETAILED DESCRIPTION

The present disclosure is presented to enable one of ordinary skill in the art to make and use the inventions set forth herein and to incorporate these inventions in the context of particular applications. Various modifications, as well as a variety of uses in different applications will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

Polymer electrolytes are viable as catholytes and polymer electrolyte separators in solid-state and semi-solid lithium-ion rechargeable batteries. For a polymer electrolyte to be technically and commercially viable, it must demonstrate sufficient ionic conductivity. A Polyvinylidene difluoride (“PVDF”), a lithium salt, such as lithium bis(trifluoromethanesulfonyl)imide (“LiTFSI”), and a cyanoresin, such as cyanoethyl polyvinyl alcohol (“CN-PVA”), formed as a polymer electrolyte according to embodiments herein exceed the threshold ionic conductivity in a wide temperature range, including at 25° C. Furthermore, the polymer electrolyte of the present disclosure can easily be manufactured into a free-standing membrane, further enhancing its technical and commercial viability as a separator between a cathode and an anode. As a free-standing membrane, the polymer electrolytes of the present disclosure can be manufactured with relative ease through solution casting and dry placement without the need to apply high pressures to the electrolyte material in the manufacturing process. When manufacturing at scale, polymer electrolytes that can form free-standing membranes have significant advantages in roll-to-roll automated manufacturing processes. The quantitative composition of the polymer electrolyte to deliver the required ionic conductivity while still forming a free-standing membrane was determined through testing. The composite cathode and separator were assembled into a rechargeable lithium-ion coin cell and was tested and measured.

### Ionic Conductivity

Ionic conductivity is a performance parameter for a polymer electrolyte, describing the movement of ions through a polymer matrix, and governs lithium-ion battery performance. Low ionic conductivity levels can lead to poor battery performance. Low ionic conductivity levels indicate a high degree of crystallinity within the polymer electrolyte. Ionic conductivity values exceeding 1×10⁻³ S/cm are highly desirable and are highly unusual for polymer electrolytes at room temperature. For reference purposes, the conventional carbonate based liquid electrolyte with a standard polypropylene (PP) separator achieves an ionic conductivity of approximately 8×10⁻⁴ S/cm. Dry polymer electrolytes that exhibit an ionic conductivity greater than 10⁻⁴ S/cm at room temperature are considered highly coveted, as crossing this threshold generally implies successful room temperature operation at acceptable C-rates (≥0.1C). But this does not mean that polymer electrolytes exhibiting ionic conductivities lower than 1×10⁻⁴ S/cm are obsolete.

Depending on the polymer electrolyte, the slight application of heat can increase ionic conductivity to levels suitable for successful operation at higher C-rates. For example, a polymer electrolyte exhibiting an ionic conductivity at 1×10⁻⁵ S/cm at room temperature may exhibit an ionic conductivity greater than 1×10⁻⁴ S/cm at temperatures exceeding 50° C. For applications where a heat source is available or heat is generated as a function of the operation of battery pack and overall device, such as electric vehicles, a polymer electrolyte with lower than 10⁻⁴ S/cm conductivity would still have great commercial interest. Therefore, dry polymer electrolytes that have ionic conductivity values of 1×10⁻⁵ S/cm or greater at room temperature are technically and commercially viable.

Ionic conductivity in the working examples of the present disclosure described below were tested using electrochemical impedance spectroscopy over a temperature ranging from 25° C. to 80° C. The frequency ranges were from 100 mHz to 1 MHz with an AC amplitude of 10 mV. Ionic conductivity (o) was calculated using the following equation:

$$σ = \frac{t}{A \times R} \qquad Equation ( 1 )$$

In equation (1), t is the thickness of the polymer electrolyte, A is the area of the stainless steel electrode, and R is the bulk resistance determined through EIS (Electrochemical Impedance Spectroscopy). The dielectric constant of a polymer plays an important role in the overall performance of the electrolyte such as ionic conductivity. A material's dielectric constant is the measure of the materials' ability to store electrical energy in an electric field. Certain components with high dielectric constants contribute significantly to increasing the ionic conductivity of a liquid electrolyte. Ethylene carbonate (EC), with a high dielectric constant of 89.78, is used in liquid electrolytes and significantly increases its ionic conductivity. A polymer with a high dielectric constant would similarly increase the ionic conductivity of a polymer electrolyte formulated with that polymer.

This relationship between the dielectric constant of a polymer and the ionic conductivity of the polymer electrolyte formulated with that polymer is further supported by the low dielectric constant of polymers used in conventional polymer electrolytes. Polymers used in conventional polymer electrolytes include polyethylene oxide (PEO), polyacrylonitrile (PAN), and polyvinyl pyrrolidone (PVP). PEO, PAN, and PVP all have low dielectric constants of less than 5.

A technically and commercially viable polymer electrolyte for rechargeable batteries must not only meet the required ionic conductivity, but it must also form a free-standing membrane such as those according to embodiments of the present disclosure described herein. A free-standing membrane has the mechanical properties required to function as a composite cathode or a separator in a solid-state battery cell. A free-standing membrane is not gel like. It is also not viscous and it is non-flowable. It is pliable when a normalized force and pressure are applied but retains its x-y dimension. As a free-standing membrane, it also stands in a form that does not require another substrate to provide structural support.

A free-standing membrane can be formed into large film-like sheets that can be manufactured at scale in automated equipment and processed into rolls. This brings significant advantages for manufacturing complete lithium-ion batteries in a roll-to-roll process. Free-standing membranes manufacturable into large film-like sheets can also be easily cut down to the appropriate size and/or shape for integration into a rechargeable lithium-ion cell.

A free-standing membrane can also be integrated into a rechargeable battery cell with other components such as the cathode and anode without the application of additional pressure or other methods to adhere the membrane to a substrate. A polymer electrolyte separator that is a free-standing membrane can be integrated with a cathode layer through dry placement even though it can also be integrated through solution casting.

The present disclosure relates to a polymer electrolyte comprising at least a polyvinylidene fluoride (“PVDF”) polymer host and a lithium salt. The polymer electrolyte is characterized by its PVDF based polymer host. The polymer electrolyte is also characterized by its high lithium salt loading. The polymer electrolyte is further characterized by a polymer blend, a cyanoethyl polyvinyl alcohol (“CN-PVA”), that adds elastic properties to the polymer electrolyte while enabling the creation of a free-standing membrane that still meets the ionic conductivity thresholds for technical and commercial viability.

The PVDF based polymer host may be a PVDF with a molecular weight of 500K to 900K, a polyvinylidene fluoride trifluoroethylene (“PVDF-TrFE”) at 50:50 to 80:20, a polyvinylidene fluoride trifluoroethylene chlorotrifluoroethylene (“PVDF-TrFE-CTFE”), a polyvinylidene fluoride trifluoroethylene chlorofluroethylene (“PVDF-TrFE-CFE”), a polyvinylidene fluoride polyacrylonitrile (“PVDF-PAN”), a polyvinylidene fluoride-co-hexafluoropropylene (“PVDF-HFP”), or a polyvinylidene fluoride chlorotrifluoroethylene (“PVDF-CTFE”).

Amorphous cyanoethylated polymers, known as cyanoresins, such as cyanoethyl polyvinyl alcohol (CN-PVA), can be used alone as a polymer host for a polymer electrolyte. CN-PVA is also known by the trade name CR-V. Cyanoethylated polymers (which includes cyanoresins) that are solids at room temperature include cyanoethyl polyvinyl alcohol (CR-V), cyanoethyl pullulan (CR-S), and a mixture of CR-V and CR-S(CR-M). CN-PVA is a rubbery solid with a relatively low glass transition temperature (Tg) of 30° C. Below this temperature, CN-PVA is a hard rubbery solid. However, above 30° C., CN-PVA becomes noticeably softer, malleable, and flexible. CN-PVA has a dielectric constant of 15 at room temperature, which increases ion dissociation and hence increases ionic conductivity. Furthermore, CN-PVA exhibits good solubility in various organic solvents and can readily be formed into free-standing membranes. The following cyanoresins have a high dielectric constant as shown below:

TABLE 1
Cyanoresin Types

| Cyanoresin Type | CR-S | CR-M | CR-V |
|---|---|---|---|
| Dielectric constant | 18 | 17 | 15 |

According to the various embodiments of the present disclosure, CN-PVA is used as a polymer blend to a polymer host for a polymer electrolyte. When PVDF is used as a polymer host, it has certain limitations. The glass transition temperature of PVDF is −40° C. At ambient temperatures, PVDF forms non-malleable films that do not exhibit elastic properties, which prevent the PE from forming intimate interfaces. For example, a polymer electrolyte based on PVDF and LiTFSI will exhibit mechanically hard, strong, and flexible film characteristics at low LiTFSI loadings. However, at high loadings, the resultant membrane is soft and tears easily. In both cases, the polymer electrolyte is incapable of forming a membrane with elastic properties.

As explained above, for a polymer electrolyte to be technically and commercially viable, it must be able to be formed into a free-standing membrane. One further desired characteristic of a free-standing membrane is elasticity. Being able to induce elastic properties in a free-standing polymer electrolyte allows a polymer electrolyte to positively enhance lithium-ion interfaces. For instance, an elastic polymer would result in a film that is stickier, resulting in a film that would adhere better to the electrode surfaces, especially in the case where the polymer electrolyte solution is cast and dried directly onto the electrode surface. An elastic polymer electrolyte would also be able to stretch to conform to expanding or shrinking interfaces. This characteristic is particularly desirable for next-generation anode materials such as lithium-metal and silicon, which experience volume changes during battery operation.

According to the various embodiments of the present disclosure, by combining the thermoplastic properties of PVDF as a polymer host and the elastic properties of CN-PVA as a polymer blend, a high performance polymer electrolyte can be formed. One advantage is that the polymer electrolyte is strong enough to ensure that electrodes do not short during battery assembly, yet soft enough to ensure good interfacial contact. Another advantage is that the polymer electrolyte can also be heated to 40-60° C. to improve interfacial contact. Yet another advantage is the combined dielectric constant value of PVDF and CN-PVA. For PVDF and CN-PVA, it is 8.4 and 15, respectively), leading to low degrees of ion association and high electrochemical performance. A further advantage is that by blending PVDF and CN-PVA, the mechanical properties of the polymer electrolyte can be customized, which is ideal when constructing a solid-state battery. For instance, when fabricating a solid-state battery cathode, the percolation of the polymer electrolyte is important. A polymer electrolyte based on CN-PVA will be able to distribute successfully upon application of heated calendering because it softens at temperatures between 20-40° C. On the other hand, if constructing a polymer electrolyte separator film (i.e., film sandwiched between the cathode and anode), a PVDF dominant polymer electrolyte would be more ideal to ensure good film forming characteristics, avoiding a short.

Polymer electrolyte systems that contain high loadings of lithiated salts are known as polymer in salt electrolytes (PiSEs). One advantage of PiSE systems is increased levels of ionic conductivity. Because the amount of charge carriers is dramatically increased through levels of lithium-salt, most polymer chains become coordinated to cations. As a result, lithium cations can easily shuttle throughout the polymer electrolyte membrane with little impedance. Other advantages of PiSEs include enhancing oxidative stability, increasing thermal stability, and a high lithium transference number.

The lithium salt may be a lithium bis(trifluoromethanesulfonyl)imide (“LiTFSI”), lithium bis(fluorosulfonyl)imide (“LiFSI”), a lithium bis(pentafluoroethanesulfonyl)imide (“LiBETI”), a lithium difluoro (oxalate) borate (“LiDFOB”), a lithium bis(oxalato)borate (“LiBOB”), a lithium tetrafluoroborate (“LiBF₄”), a lithium perchlorate (“LiClO₄”), a lithium nitrate (“LiNO₃”), or a lithium difluorobis(oxalato) phosphate (LiDFOP).

For a polymer electrolyte to form a free-standing membrane having the characteristics described above and meet the necessary ionic conductivity thresholds, its components must be maintained within certain weight percentage ranges. These weight percentage ranges are constrained by several competing effects that vary depending on the composition of the electrolyte. First, a higher polymer composition, including that from a polymer host and a polymer blend, leads to, generally, better mechanical characteristics, but lower ionic conductivity. But as mechanical characteristics improve, which include increased hardness and strength, the polymer electrolyte loses elasticity, which is also a desirable characteristic. Hence, excessive polymer composition is not favorable.

Second, higher lithium salt composition generally leads to increased levels of ionic conductivity. But excessive lithium salt composition comes at the cost of a reduction in polymer content, which reduces the polymer electrolyte's mechanical characteristics. Further, excessive lithium salt composition can reduce ionic conductivity. With high lithium salt composition, the number of Li+ cations and anions increase. The Li+ cations become trapped in an ion crosslinking formation, while the anions stay out of the Li+ cation's path due to high concentration. This results in a disorder in the polymer matrix and anions must migrate via the polymer backbone formed by the polymer host and polymer blend. But due to the low polymer content (because of the high lithium salt composition), the anions can no longer migrate and dissociation between cations and anions decrease, leading to lower ionic conductivity. Therefore, lithium salt composition cannot be excessive.

Third, the addition of a polymer blend, such as a CN-PVA in certain embodiments of the present disclosure, itself contributes to ionic conductivity as CN-PVA is electrochemically active. But increased CN-PVA content comes at the cost of PVDF content from the polymer host, which is not electroactive. Increased CN-PVA can also cause the polymer electrolyte to become excessively soft and sticky. At that point, the benefits of a polymer electrolyte that distributes better on an electrode surface upon application of heated calendering and/or adheres better to the electrode surface outweigh the characteristics of hardness and strength required for the polymer electrolyte to perform as an effective separator film.

According to one embodiment of the present disclosure, the polymer electrolyte comprises a PVDF (534K) as a polymer host, a CN-PVA as a polymer blend, and a LiTFSI as a lithium salt by weight percentage as follows:

| Component | Composition (wt %) |
|---|---|
| PVDF (534K) | 15-55 |
| CN-PVA | 5-40 |
| LiTFSI | 40-70 |

According to another embodiment of the present disclosure, the polymer electrolyte comprises a PVDF (700K) as a polymer host, a CN-PVA as a polymer blend, and a LiTFSI as a lithium salt by weight percentage as follows:

| Component | Composition (wt %) |
|---|---|
| PVDF (700K) | 15-55 |
| CN-PVA | 5-35 |
| LiTFSI | 40-80 |

In both embodiments, the polymer electrolyte has an ionic conductivity value that exceeds that required for technical and commercial viability. The polymer electrolytes of both embodiments can also be formed free standing membrane that has the necessary level of mechanical strength and hardness without sacrificing elasticity.

### Preparation of Polymer Electrolyte Solution and Composite Cathode

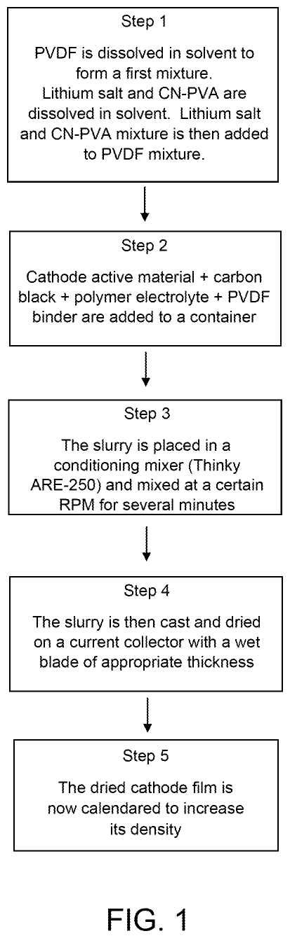

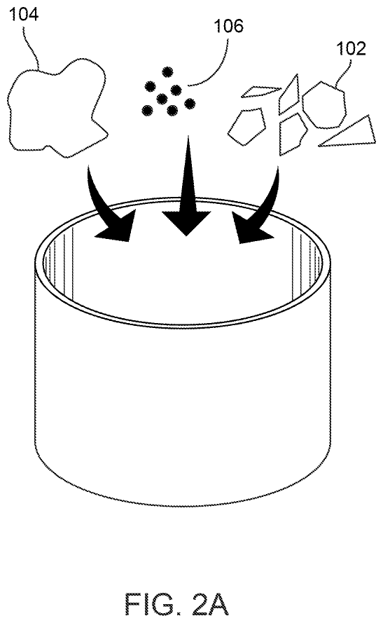

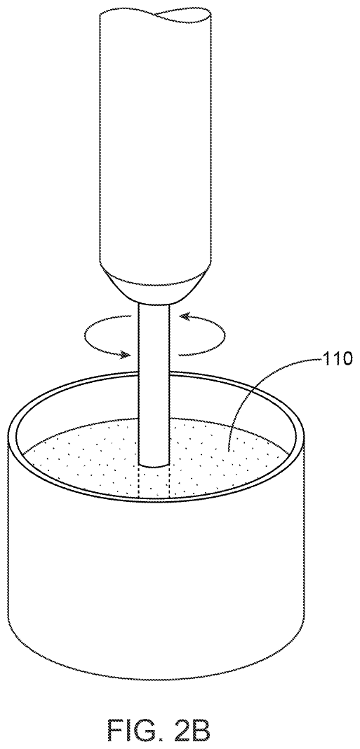

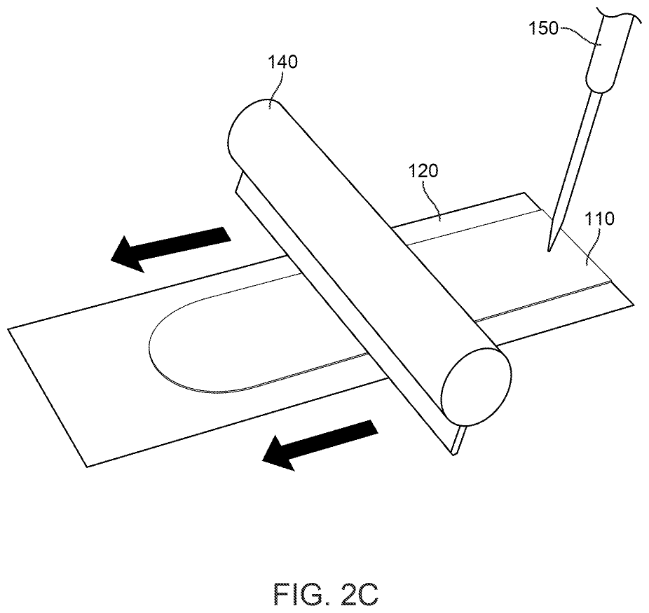

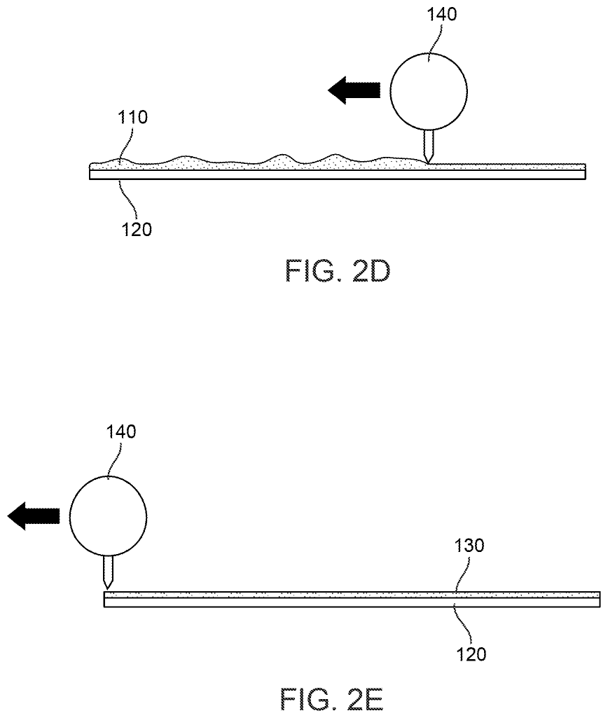

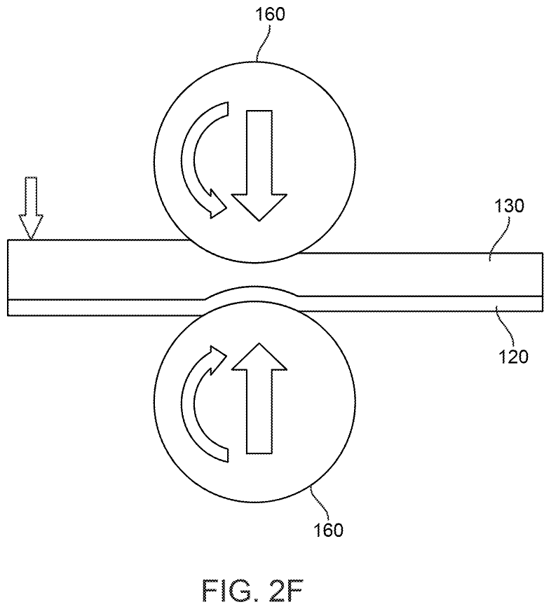

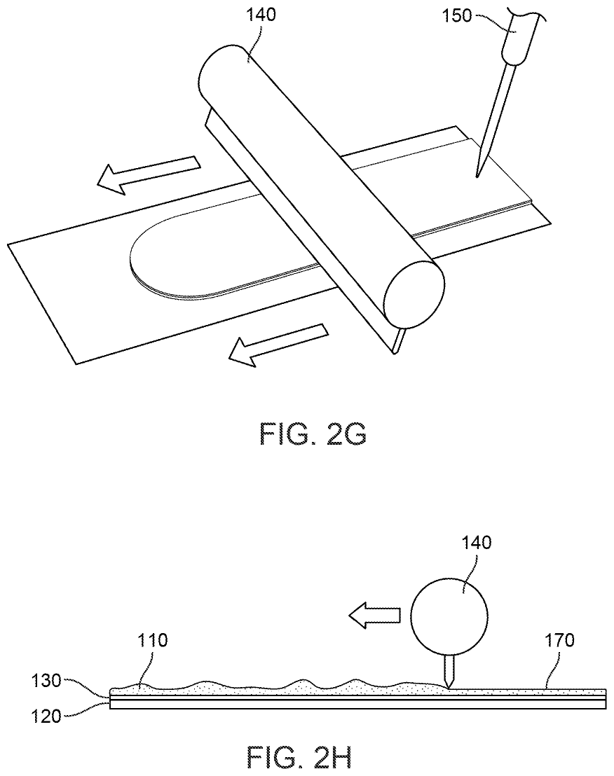

Next, an example of preparing a polymer electrolyte and a composite cathode according to an embodiment of the present disclosure will be described in relation to FIGS. 1 and 2A-2H.

FIG. 1 is a flow chart illustrating the steps of preparing a polymer electrolyte and preparing a composite cathode based on the polymer electrolyte according to an embodiment of the present disclosure. In Step 1, the polymer electrolyte mixture is prepared. In Step 2, the polymer electrolyte is mixed with a cathode active material and other components to form a slurry. In Step 3, the slurry is mixed. In Step 4, the slurry is solution cast and dried onto a current collector to form a composite cathode film. In Step 5, the solution casted composite cathode film is calendered.

FIG. 2A is a perspective view illustrating the preparation of a polymer electrolyte. This corresponds to Step 1 of FIG. 1. In a first container, a polymer host 102, such as a PVDF, is dissolved in an organic solvent, such as N-methyl-2-pyrrolidone (NMP) or dimethylformamide (DMF). The polymer host mixture is heated and agitated to promote the dissolution of the polymer host in the organic solvent. A lithium salt 104, such as a LiTFSI, is dried in a vacuum oven at a temperature of 80° C. to 120° C. for approximately 8 hours to remove moisture (not shown) to form a dried lithium salt. In a second container (not shown), a polymer blend, such as a CN-PVA 106, is also dissolved in an organic solvent to form a mixture. The polymer blend mixture is also heated and agitated. The dried lithium salt 104 is added to the polymer blend mixture, until a homogenous mixture is obtained. The homogenous mixture is then mixed with the polymer host mixture to obtain a mixture of polymer host, polymer blend, and lithium salt. The mixture is then mixed under heat until all components are homogenously distributed.

FIG. 2B is a perspective view illustrating the preparation of a slurry mixture for forming a polymer electrolyte composite cathode. FIG. 2B corresponds to Step 2 and Step 3 of FIG. 1. A cathode active material, carbon black, polyvinylidene difluoride (PVDF) binder, and the polymer electrolyte mixture are mixed in a container to form a slurry 110. 70% cathode active material, 10 wt % carbon black, 15 wt % polymer electrolyte, and 5 wt % PVDF binder can be used in the slurry mixture. The slurry is transferred to a conditioning mixer (e.g., a Thinky ARE-250) and mixed at certain revolutions per minute (RPM) for several minutes until the mixture is homogenous. The polymer electrolyte functions as a catholyte in the composite cathode.

FIG. 2C is a perspective view illustrating the solution casting and doctor blading of a slurry mixture to form the composite cathode. This corresponds to Step 4 of FIG. 1. The slurry 110 is cast onto a current collector 120 that is 16 μm thick with an applicator 150. Suitable current collectors include aluminum current collectors, although copper based current collectors such as copper foils can be used. The organic solvent, in this example NMP, is evaporated until a dense, dry, and black film remains. Although the organic solvent can be removed by evaporation, removal of a solvent is not limited to evaporation. Other methods of removing a solvent include distillation, filtration, extraction, crystallization, centrifugation, and adsorption. A doctor blade 140 is then applied to the cast slurry mixture to flatten the slurry mixture 110 onto the current collector 120, resulting in a composite cathode film 130 (FIG. 2E). The doctor blade 140 should be a wet blade of appropriate thickness. FIG. 2D is a side view illustrating the solution casting and doctor blading of the slurry mixture 110 to form the composite cathode film 130 (FIG. 2E). The doctor blade 140 moves across the solution cast slurry mixture 110 to flatten the slurry mixture. FIG. 2E is a side view illustrating the slurry mixture 110 on the current collector 120 after doctor blading to form the cathode film 130. The composite cathode film is then heated to 60° C. to remove any remaining solvent in the slurry mixture.

FIG. 2F illustrates the calendering of the composite cathode film. This corresponds to Step 5 of FIG. 1. The composite cathode film 130 and current collector 120 are fed through a set of rollers 160. The rollers 160 together rotate in their respective directions as indicated by the arrows to draw in the composite cathode film 130 and current collector 120 and apply a compressing force to calender the cathode film 130 and current collector 120. The cathode film 130 is calendered to increase its density to 1.7 g/cm³.

### Preparation of Polymer Electrolyte Separator

Next, an example of a polymer electrolyte separator formed using the polymer electrolyte of the present disclosure will be described in relation to FIGS. 2G and 2H.

FIG. 2G is a perspective view illustrating the solution casting of a polymer electrolyte separator using the polymer electrolyte, according to an embodiment of the present disclosure. The polymer electrolyte mixture 110 is solution cast onto the composite cathode film 130, formed as explained above with reference to FIGS. 2A through 2F, by means of an applicator 150. One example of an applicator is a dropper, but any device by which a small amount of the mixture 110 can be applied to the composite cathode 100 and then dispersed can be used. FIG. 2H is a side view illustrating the doctor blading of the solution cast polymer electrolyte separator, according to an embodiment of the present disclosure. Once the mixture 110 is cast onto the formed composite cathode film 130, a doctor blade 140 is used to spread the mixture 110 to form an even layer over the entire surface of the composite cathode film 130. The organic solvent in the mixture 110 is allowed to evaporate, forming a polymer electrolyte layer 170. When formed in this manner, the polymer electrolyte layer 170 fuses with the composite cathode film 130 and does not misalign or detach.

The solution cast method for casting a polymer electrolyte as a separator according to the embodiment of the present disclosure described herein has several benefits. First, as between an electrode and the polymer electrolyte, the electrode-electrolyte interfacial impedance is very low. This is because the polymer electrolyte is in direct contact with the electrode. This is regardless of whether the electrode that the polymer electrolyte is solution cast onto is a cathode or an anode. Polymer electrolytes that are directly cast onto the cathode can exhibit better electrochemical performance at higher C-rates. Second, it is a scalable and cost effective method to integrate polymer electrolyte films into solid-state batteries. However, the polymer electrolyte separator of the present disclosure can also be cast onto a separate substrate, peeled off, and then dry placed onto the composite cathode film.

Solution casting the polymer electrolyte as a separator is not limited to forming a single polymer electrolyte layer. The solution casting method can be repeated multiple times to form a separator comprising multiple polymer electrolyte separator layers. Depending on the overall cell design, multiple polymer electrolyte layers can be formed to create a separator of 100 μm or greater to improve performance of separator function to protect against penetration of the separator by dendrites.

The polymer electrolyte present in the composite cathode functioning as a catholyte and the polymer electrolyte separator have the same ionic conductivity. Although the polymer electrolyte separator is formulated with the same polymer electrolyte embodiment as used in the composite cathode, the polymer electrolyte separator is not limited to the same embodiment and can be formulated with a polymer electrolyte of a different embodiment in the present disclosure.

### Lithium-Ion Rechargeable Cell

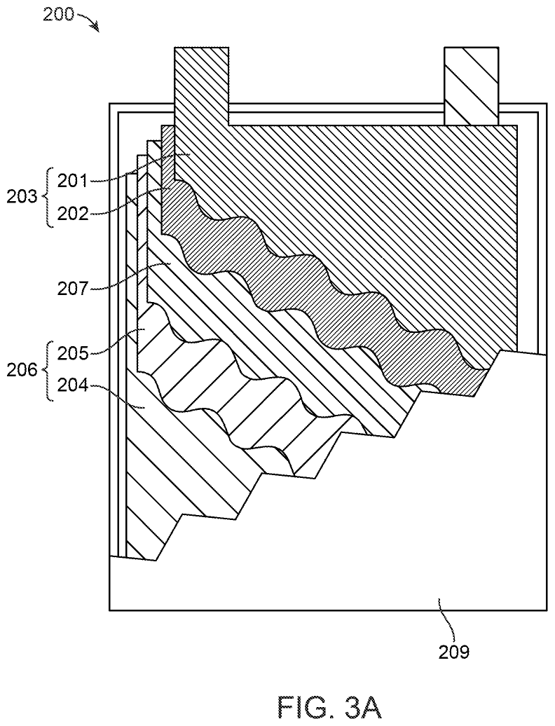

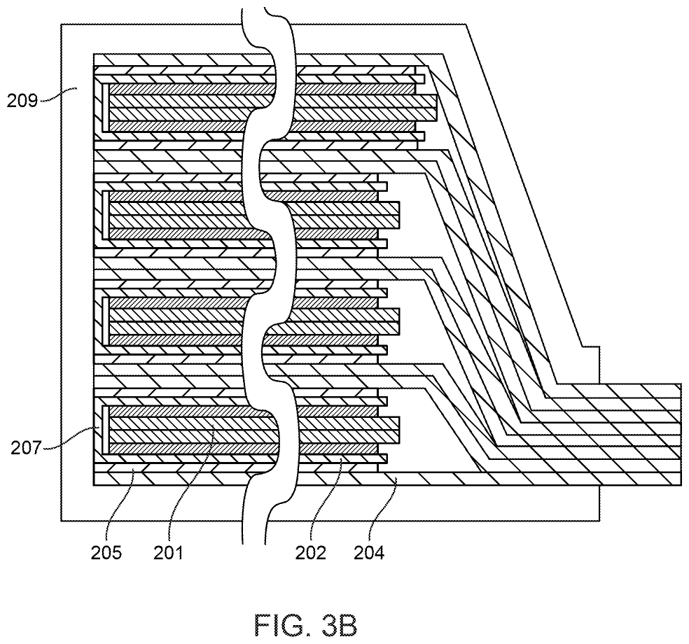

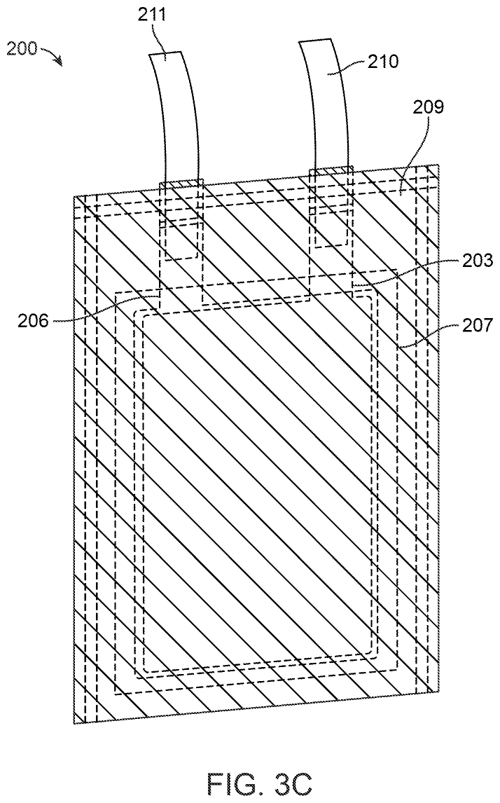

Next, an example of a rechargeable battery cell using the composite cathode, and the polymer electrolyte separator according to embodiment of the present disclosure will be described in relation to FIGS. 3A-3C.

FIG. 3A illustrates a rechargeable battery cell 200 according to embodiment of the present disclosure. The cell 200 includes a cathode current collector 201, a composite cathode film 202, an anode current collector 204, and an anode active material layer 205. The composite cathode film 202 of the present disclosure, comprising a PVDF, a lithium salt, and a CN-PVA, and the cathode current collector 201 together form the composite cathode 203. The anode active material layer 205 and the anode current collector 204 together form the anode 206. A polymer electrolyte separator 207 of the present disclosure, comprising a PVDF, a lithium salt, and a CN-PVA, separates the composite cathode 203 and the anode 206. In one example, the composite cathode 203 is cut to 50 mm×34 mm in size and the anode 206 is cut to 49 mm×33 mm in size. The composite cathode 203 is intentionally cut so that it is larger than the anode 206 to prevent an internal short circuit due to contact of the cathode with the anode.

In FIG. 3A, cathode current collector 201 and the anode current collector 204 also serve as terminals for electrical contact with an external portion. For this reason, the cathode current collector 201 and the anode current collector 204 may be arranged to be partly exposed to the outside of the exterior body 209. Alternatively, the cathode current collector 201 or the anode current collector 204 may be bonded to each other by ultrasonic welding, and instead of the positive electrode current collector 201 and the negative electrode current collector 204, the lead electrode may be exposed to the outside of the exterior body 209.

In some embodiments, non-conductive inserts (not shown in FIGS. 3A and 3B) are added at each end of the stack of the rechargeable battery cell. The non-conductive inserts add mechanical rigidity to the stack. A polyolefin film (not shown) can also be tightly wrapped around the stack to ensure that the components of the stack do not shift and remain in interfacial contact with each other.

As the exterior body 209 of the rechargeable battery cell 200, for example, a laminate film having a multi-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 3B illustrates an example of a cross-sectional structure of the rechargeable battery cell 200. Although FIG. 3A illustrates an example including only two current collectors for simplicity, an actual battery includes a plurality of electrode stacks. The example in FIG. 3B includes 16 electrode layers. The rechargeable battery cell 200 has flexibility even though it includes 16 electrode layers. FIG. 3B illustrates a structure including 8 layers of anode current collectors 204 and 8 layers of cathode current collectors 201, i.e., 16 layers in total. It also illustrates the cathode film 202 and the polymer electrolyte separator 207 of the present disclosure. Although FIG. 3B illustrates a cross section of the lead portion of the negative electrode, and the 8 anode current collectors 204 are bonded to each other by ultrasonic welding, the number of electrode layers is not limited to 16, and may be more than 16 or fewer than 16. With many electrode layers, the rechargeable battery cell can have a higher capacity. In contrast, with a small number of electrode layers, the rechargeable battery can be thinner and have greater flexibility.

FIG. 3C illustrates an example of a perspective view of the rechargeable battery cell 200. As shown in FIG. 3C, a nickel tab 210 is welded onto the composite cathode 203 and a nickel tab 211 is also welded onto the anode 206. The polymer electrolyte separator 207 of the present disclosure, comprising a PVDF, a lithium salt, and a CN-PVA, can also be seen. The weld and internal/external tab portions can be covered with Kapton tape (not shown) to prevent a short-circuit.

### Examples 1-1 through 1-37 (PVDF 534K)

In Examples 1-1 through 1-37 described below, a series of polymer electrolyte compositions were formed into a polymer electrolyte separator according to various embodiments of the present disclosure, and were tested. PVDF (534K) was used in Examples 1-1 through 1-37 in comparison to PVDF (700K) in Examples 2-1 through 2-37. In some examples, the polymer electrolyte mixtures were successfully formed into polymer electrolyte separator layers and ionic conductivity values at 25° C., 50° C., and 80° C. were measured. In other examples, a polymer electrolyte separator layer could not be formed.

### Example 1-1

In Example 1-1, a polymer electrolyte was prepared using the method for preparation of a polymer electrolyte mixture of the present disclosure. In a first container, a PVDF (534K) was dissolved in an organic solvent NMP. The PVDF (534K) mixture was heated and agitated to promote the dissolution of the PVDF (534K) in the organic solvent. LiTFSI, was dried in a vacuum oven at a temperature of 80° C. to 120° C. for approximately 8 hours to remove moisture. In a second container, a CN-PVA was dissolved in organic solvent to form a mixture. The mixture was then heated and agitated. The dried LiTFSI was added to the CN-PVA mixture until a homogenous mixture was obtained. The homogenous mixture was then mixed with the PVDF (534K) mixture to eventually obtain a mixture of 55 wt % PVDF (534K), 5 wt % CN-PVA, and 40 wt % LiTFSI. The PVDF (534K), CN-PVA, and LiTFSI mixture was then mixed under heat until all components were homogenously distributed.

A polymer electrolyte separator layer was prepared using the method for preparing a solid polymer electrolyte separator with the polymer electrolyte of the present disclosure. The polymer electrolyte mixture was solution cast by means of a dropper. After the polymer electrolyte was solution cast, a film applicator, such as a doctor blade, was used to spread the mixture to form an even layer. The organic solvent in the polymer electrolyte mixture was removed through evaporation over time, eventually solidifying into the polymer electrolyte separator layer.

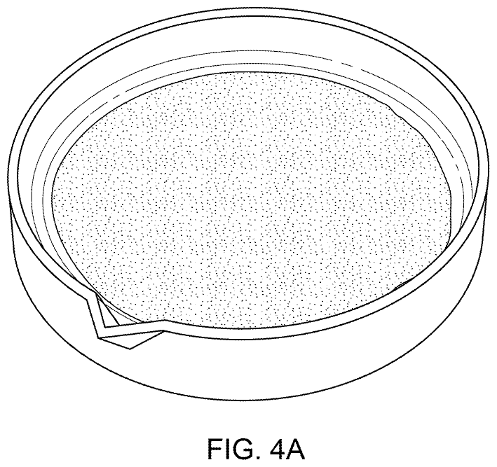

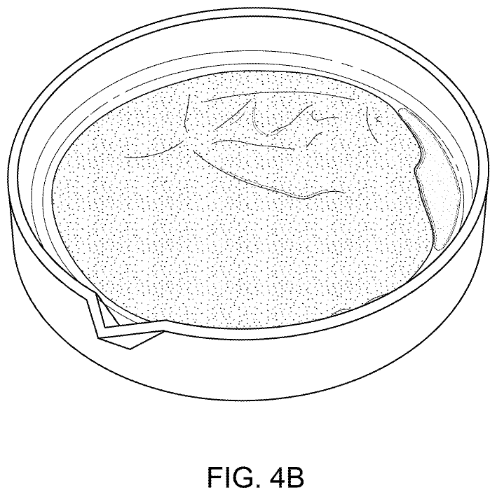

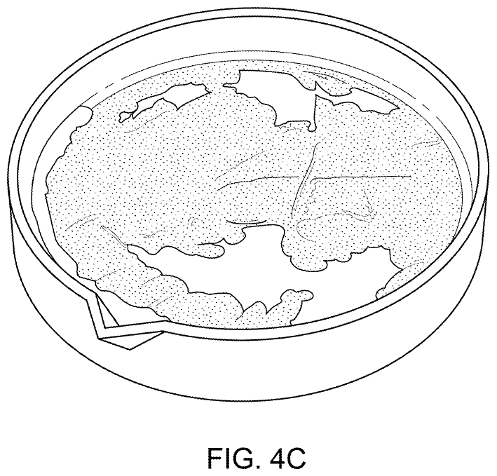

The polymer electrolyte of Example 1-1 was formed into a mechanically stable polymer electrolyte separator film like the film in FIG. 4A. The ionic conductivity of the polymer electrolyte separator was measured at 25° C., 50° C., and 80° C. The polymer electrolyte separator exhibited ionic conductivity of 4.97×10⁻⁴ S/cm at 25° C., 1.06×10⁻³ S/cm at 50° C., and 2.01×10⁻³ S/cm at 80° C.

### Example 1-2

In Example 1-2, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 45 wt % PVDF (534K), 5 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-2 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.36×10⁻³ S/cm at 25° C., 2.34×10⁻³ S/cm at 50° C., and 4.59×10⁻³ S/cm at 80° C.

### Example 1-3

In Example 1-3, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 35 wt % PVDF (534K), 5 wt % CN-PVA, and 60 wt % LiTFSI.

A polymer electrolyte separator layer was also prepared using the method for preparing a solid polymer electrolyte separator of the present disclosure like in Example 1-1. The polymer electrolyte of Example 1-3 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.64×10⁻³ S/cm at 25° C., 2.78×10⁻³ S/cm at 50° C., and 4.06×10⁻³ S/cm at 80° C.

### Example 1-4

In Example 1-4, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 30 wt % PVDF (534K), 5 wt % CN-PVA, and 65 wt % LiTFSI.

A polymer electrolyte separator layer was also prepared using the method for preparing a solid polymer electrolyte separator of the present disclosure like in Example 1-1. The polymer electrolyte of Example 1-4 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 7.25×10⁻⁴ S/cm at 25° C., 1.63×10⁻³ S/cm at 50° C., and 2.84×10⁻³ S/cm at 80° C.

### Example 1-5

In Example 1-5, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 25 wt % PVDF (534K), 5 wt % CN-PVA, and 70 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-6

In Example 1-6, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 5 wt % CN-PVA, and 80 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-7

In Example 1-7, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 50 wt % PVDF (534K), 10 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-7 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 5.34×10⁻⁴ S/cm at 25° C., 1.57×10⁻³ S/cm at 50° C., and 2.48×10⁻³ S/cm at 80° C.

### Example 1-8

In Example 1-8, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 40 wt % PVDF (534K), 10 wt % CN-PVA, and 50 wt % LiTFSI.

A polymer electrolyte separator layer was also prepared using the method for preparing a solid polymer electrolyte separator of the present disclosure like in Example 1-1.

The polymer electrolyte of Example 1-8 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.72×10⁻⁵ S/cm at 25° C., 1.27×10⁻⁴ S/cm at 50° C., and 2.82×10⁻⁴ S/cm at 80° C.

### Example 1-9

In Example 1-9, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 30 wt % PVDF (534K), 10 wt % CN-PVA, and 60 wt % LiTFSI.

A polymer electrolyte separator layer was also prepared using the method for preparing a solid polymer electrolyte separator of the present disclosure like in Example 1-1. The polymer electrolyte of Example 1-9 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.67×10⁻⁴ S/cm at 25° C., 4.98×10⁻⁴ S/cm at 50° C., and 1.16×10⁻³ S/cm at 80° C.

### Example 1-10

In Example 1-10, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 10 wt % CN-PVA, and 70 wt % LiTFSI.

A polymer electrolyte separator layer was also prepared using the method for preparing a solid polymer electrolyte separator of the present disclosure like in Example 1-1. The polymer electrolyte of Example 1-10 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 2.30×10⁻⁴ S/cm at 25° C., 1.45×10⁻³ S/cm at 50° C., and 2.94×10⁻³ S/cm at 80° C.

### Example 1-11

In Example 1-11, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 10 wt % CN-PVA, and 75 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-12

In Example 1-12, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 10 wt % PVDF (534K), 10 wt % CN-PVA, and 80 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-13

In Example 1-13, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 45 wt % PVDF (534K), 15 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-13 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 7.29×10⁻⁵ S/cm at 25° C., 2.70×10⁻⁴ S/cm at 50° C., and 8.15×10⁻⁴ S/cm at 80° C.

### Example 1-14

In Example 1-14, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 35 wt % PVDF (534K), 15 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-14 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 9.59×10⁻⁵ S/cm at 25° C., 4.43×10⁻⁴ S/cm at 50° C., and 1.30×10⁻³ S/cm at 80° C.

### Example 1-15

In Example 1-15, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 25 wt % PVDF (534K), 15 wt % CN-PVA, and 60 wt % LiTFSI.

A polymer electrolyte separator layer was also prepared using the method for preparing a solid polymer electrolyte separator of the present disclosure like in Example 1-1. The polymer electrolyte of Example 1-15 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 6.42×10⁻⁴ S/cm at 25° C., 1.95×10⁻³ S/cm at 50° C., and 2.69×10⁻³ S/cm at 80° C.

### Example 1-16

In Example 1-16, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 15 wt % CN-PVA, and 65 wt % LiTFSI.

A polymer electrolyte separator layer was also prepared using the method for preparing a solid polymer electrolyte separator of the present disclosure like in Example 1-1. The polymer electrolyte of Example 1-16 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 5.10×10⁻⁴ S/cm at 25° C., 1.50×10⁻³ S/cm at 50° C., and 2.44×10⁻³ S/cm at 80° C.

### Example 1-17

In Example 1-17, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 15 wt % CN-PVA, and 70 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-18

In Example 1-18, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 40 wt % PVDF (534K), 20 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-18 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 7.12×10⁻⁶ S/cm at 25° C., 5.42×10⁻⁵ S/cm at 50° C., and 2.27×10⁻⁴ S/cm at 80° C.

### Example 1-19

In Example 1-19, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 30 wt % PVDF (534K), 20 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-19 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 4.28×10⁻⁵ S/cm at 25° C., 1.90×10⁻⁴ S/cm at 50° C., and 9.16×10⁻⁴ S/cm at 80° C.

### Example 1-20

In Example 1-20, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 20 wt % CN-PVA, and 60 wt % LiTFSI.

A polymer electrolyte separator layer was also prepared using the method for preparing a solid polymer electrolyte separator of the present disclosure like in Example 1-1. The polymer electrolyte of Example 1-20 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.98×10⁻⁴ S/cm at 25° C., 7.77×10⁻⁴ S/cm at 50° C., and 1.40×10⁻³ S/cm at 80° C.

### Example 1-21

In Example 1-21, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 20 wt % CN-PVA, and 65 wt % LiTFSI.

A polymer electrolyte separator layer was also prepared using the method for preparing a solid polymer electrolyte separator of the present disclosure like in Example 1-1. The polymer electrolyte of Example 1-21 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 3.15×10⁻⁴ S/cm at 25° C., 1.35×10⁻³ S/cm at 50° C., and 2.47×10⁻³ S/cm at 80° C.

### Example 1-22

In Example 1-22, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 10 wt % PVDF (534K), 20 wt % CN-PVA, and 70 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-23

In Example 1-23, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 35 wt % PVDF (534K), 25 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-23 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 2.43×10⁻⁵ S/cm at 25° C., 9.81×10⁻⁵ S/cm at 50° C., and 4.86×10⁻⁴ S/cm at 80° C.

### Example 1-24

In Example 1-24, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 25 wt % PVDF (534K), 25 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-24 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 8.99×10⁻⁵ S/cm at 25° C., 2.82×10⁻⁴ S/cm at 50° C., and 9.89×10⁻⁴ S/cm at 80° C.

### Example 1-25

In Example 1-25, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 25 wt % CN-PVA, and 55 wt % LiTFSI.

A polymer electrolyte separator layer was also prepared using the method for preparing a solid polymer electrolyte separator of the present disclosure like in Example 1-1. The polymer electrolyte of Example 1-25 was formed into mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.21×10⁻⁴ S/cm at 25° C., 4.57×10⁻⁴ S/cm at 50° C., and 1.38×10⁻³ S/cm at 80° C.

### Example 1-26

In Example 1-26, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 25 wt % CN-PVA, and 60 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-27

In Example 1-27, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 30 wt % PVDF (534K), 30 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-27 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.38×10⁻⁵ S/cm at 25° C., 1.78×10⁻⁴ S/cm at 50° C., and 5.98×10⁻⁴ S/cm at 80° C.

### Example 1-28

In Example 1-28, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 30 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-28 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.15×10⁻⁴ S/cm at 25° C., 2.98×10⁻⁴ S/cm at 50° C., and 1.06×10⁻³ S/cm at 80° C.

### Example 1-29

In Example 1-29, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 30 wt % CN-PVA, and 55 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-30

In Example 1-30, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 25 wt % PVDF (534K), 35 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-30 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.72×10⁻⁵ S/cm at 25° C., 1.05×10⁻⁴ S/cm at 50° C., and 3.25×10⁻⁴ S/cm at 80° C.

### Example 1-31

In Example 1-31, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 35 wt % CN-PVA, and 50 wt % LiTFSI.

A polymer electrolyte separator layer was also prepared using the method for preparing a solid polymer electrolyte separator of the present disclosure like in Example 1-1. The polymer electrolyte of Example 1-31 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 3.99×10⁻⁵ S/cm at 25° C., 1.62×10⁻⁴ S/cm at 50° C., and 1.98×10⁻⁴ S/cm at 80° C.

### Example 1-32

In Example 1-32, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 10 wt % PVDF (534K), 35 wt % CN-PVA, and 55 wt % LiTFSI.

An attempt was also made to prepare a polymer electrolyte separator layer using the method for preparing a solid polymer electrolyte separator of the present disclosure like in Example 1-1.

The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 1-33

In Example 1-33, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 20 wt % PVDF (534K), 40 wt % CN-PVA, and 40 wt % LiTFSI.

A polymer electrolyte separator layer was also prepared using the method for preparing a solid polymer electrolyte separator of the present disclosure like in Example 1-1. The polymer electrolyte of Example 1-33 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 3.36×10⁻⁵ S/cm at 25° C., 1.01×10⁻⁴ S/cm at 50° C., and 1.93×10⁻⁴ S/cm at 80° C.

### Example 1-34

In Example 1-34, a polymer electrolyte mixture was also prepared using the method for preparation of a polymer electrolyte mixture of the present disclosure like in Example 1-1. PVDF (534K) was used as the polymer host, LiTFSI was used as the lithium salt, and CN-PVA was used as the polymer blend. The polymer electrolyte mixture was comprised of 15 wt % PVDF (534K), 40 wt % CN-PVA, and 45 wt % LiTFSI.

An attempt was also made to prepare a polymer electrolyte separator layer using the method for preparing a solid polymer electrolyte separator of the present disclosure like in Example 1-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Examples 1-35, 1-36, and 1-37

In Examples 1-35, 1-36, and 1-37, polymer electrolyte mixtures were also prepared using the method for preparation of a polymer electrolyte mixture of the present disclosure like in Example 1-1. The polymer electrolyte mixture of Example 1-35 was comprised of 15 wt % PVDF (534K), 45 wt % CN-PVA, and 40 wt % LiTFSI. The polymer electrolyte mixture of Example 1-36 was comprised of 10 wt % PVDF (534K), 45 wt % CN-PVA, and 45 wt % LiTFSI. The polymer electrolyte mixture of Example 1-37 was comprised of 5 wt % PVDF (534K), 45 wt % CN-PVA, and 50 wt % LiTFSI.

In Examples 1-35, 1-36, and 1-37, attempts were also made to prepare polymer electrolyte separator layers using the method for preparing a solid polymer electrolyte separator of the present disclosure like in Example 1-1. The compositions could not be formed into mechanically stable polymer electrolyte separator films.

TABLE 2
Summary of Working Examples 1-1 through 1-37

| | PVDF (534K) | CN-PVA | Lithium Salt | Ionic Conductivity (S/cm) | | |
|---|---|---|---|---|---|---|
| Examples | (wt %) | (wt %) | LiTFSI (wt %) | 25 C. ° | 50 C. ° | 80 C. ° |
| 1-1 | 55 | 5 | 40 | 4.97 × 10⁻⁴ | 1.06 × 10⁻³ | 2.01 × 10⁻³ |
| 1-2 | 45 | | 50 | 1.36 × 10⁻³ | 2.34 × 10⁻³ | 4.59 × 10⁻³ |
| 1-3 | 35 | | 60 | 1.64 × 10⁻³ | 2.78 × 10⁻³ | 4.06 × 10⁻³ |
| 1-4 | 30 | | 65 | 7.25 × 10⁻⁴ | 1.63 × 10⁻³ | 2.84 × 10⁻³ |
| 1-5 | 25 | | 70 | Could not form free-standing membrane | | |
| 1-6 | 15 | | 80 | Could not form free-standing membrane | | |
| 1-7 | 50 | 10 | 40 | 5.34 × 10⁻⁴ | 1.57 × 10⁻³ | 2.48 × 10⁻³ |
| 1-8 | 40 | | 50 | 3.72 × 10⁻⁵ | 1.27 × 10⁻⁴ | 2.82 × 10⁻⁴ |
| 1-9 | 30 | | 60 | 1.67 × 10⁻⁴ | 4.98 × 10⁻⁴ | 1.16 × 10⁻³ |
| 1-10 | 20 | | 70 | 2.30 × 10⁻⁴ | 1.45 × 10⁻³ | 2.94 × 10⁻³ |
| 1-11 | 15 | | 75 | Could not form free-standing membrane | | |
| 1-12 | 10 | | 80 | Could not form free-standing membrane | | |
| 1-13 | 45 | 15 | 40 | 7.29 × 10⁻⁵ | 2.70 × 10⁻⁴ | 8.15 × 10⁻⁴ |
| 1-14 | 35 | | 50 | 9.59 × 10⁻⁵ | 4.43 × 10⁻⁴ | 1.30 × 10⁻³ |
| 1-15 | 25 | | 60 | 6.42 × 10⁻⁴ | 1.95 × 10⁻³ | 2.69 × 10⁻³ |
| 1-16 | 20 | | 65 | 5.10 × 10⁻⁴ | 1.50 × 10⁻³ | 2.44 × 10⁻³ |
| 1-17 | 15 | | 70 | Could not form free-standing membrane | | |
| 1-18 | 40 | 20 | 40 | 7.12 × 10⁻⁶ | 5.42 × 10⁻⁵ | 2.27 × 10⁻⁴ |
| 1-19 | 30 | | 50 | 4.28 × 10⁻⁵ | 1.90 × 10⁻⁴ | 9.16 × 10⁻⁴ |
| 1-20 | 20 | | 60 | 1.98 × 10⁻⁴ | 7.77 × 10⁻⁴ | 1.40 × 10⁻³ |
| 1-21 | 15 | | 65 | 3.15 × 10⁻⁴ | 1.35 × 10⁻³ | 2.47 × 10⁻³ |
| 1-22 | 10 | | 70 | Could not form free-standing membrane | | |
| 1-23 | 35 | 25 | 40 | 2.43 × 10⁻⁵ | 9.81 × 10⁻⁵ | 4.86 × 10⁻⁴ |
| 1-24 | 25 | | 50 | 8.99 × 10⁻⁵ | 2.82 × 10⁻⁴ | 9.89 × 10⁻⁴ |
| 1-25 | 20 | | 55 | 1.21 × 10⁻⁴ | 4.57 × 10⁻⁴ | 1.38 × 10⁻³ |
| 1-26 | 15 | | 60 | Could not form free-standing membrane | | |
| 1-27 | 30 | 30 | 40 | 3.38 × 10⁻⁵ | 1.78 × 10⁻⁴ | 5.98 × 10⁻⁴ |
| 1-28 | 20 | | 50 | 1.15 × 10⁻⁴ | 2.98 × 10⁻⁴ | 1.06 × 10⁻³ |
| 1-29 | 15 | | 55 | Could not form free-standing membrane | | |
| 1-30 | 25 | 35 | 40 | 1.72 × 10⁻⁵ | 1.05 × 10⁻⁴ | 3.25 × 10⁻⁴ |
| 1-31 | 15 | | 50 | 3.99 × 10⁻⁵ | 1.62 × 10⁻⁴ | 1.98 × 10⁻⁴ |
| 1-32 | 10 | | 55 | Could not form free-standing membrane | | |
| 1-33 | 20 | 40 | 40 | 3.36 × 10⁻⁵ | 1.01 × 10⁻⁴ | 1.93 × 10⁻⁴ |

| | | | | |
|---|---|---|---|---|
| 1-34 | 15 | | 45 | Could not form free-standing membrane |
| 1-35 | 15 | 45 | 40 | Could not form free-standing membrane |
| 1-36 | 10 | | 45 | Could not form free-standing membrane |
| 1-37 | 5 | | 50 | Could not form free-standing membrane |

The working Examples 1-1 through 1-37 demonstrate the compositions of PVDF (534K), CN-PVA, and lithium salt that form a free-standing membrane and meet the required ionic conductivity threshold for technical and commercial viability. First, Examples 1-1 through 1-37 together demonstrate the levels of CN-PVA at which a free-standing membrane with the required ionic conductivity is formed. Examples 1-1 through 1-4 demonstrate that at a minimum level of 5 wt % CN-PVA is required; Example 1-33 demonstrates that a maximum level of 40 wt % CN-PVA can be used. Examples 1-35 through 1-37 demonstrate that when CN-PVA is at 45 wt %, no free-standing membrane can be formed with any combination of PVDF (534K) and LiTFSI. A person of ordinary skill in the art would also understand that from Examples 1-1 through 1-37, taken together, that at no levels of CN-PVA at 45 wt % and above, a free-standing membrane can be formed.

Second, Examples 1-1 through 1-37 together demonstrate that at least a range of 15 wt % to 55 wt % PVDF (534K) can be used, given the useable levels of CN-PVA between 5-40 wt %. Example 1-21 supports the use of as low as 15 wt % PVDF (534K). Example 1-1 supports the use of much as 55 wt % PVDF (534K). A person of ordinary skill in the art would also understand that in the polymer electrolyte of the present disclosure, as a PiSE system, a polymer content of 60 wt % (55 wt % PVDF (534K) and 5 wt % CN-PVA) should not be exceeded to maintain a 40 wt % lithium salt content.

Third, Examples 1-1 through 1-37 together demonstrate that at least a range of 40 wt % to 70 wt % LiTFSI can be used, given the useable levels of CN-PVA between 5-40 wt %. Examples 1-1 and 1-7 support the use of as low as 40 wt % LiTFSI. Example 1-10 supports the use of as much as 70 wt % LiTFSI.

Thus, according one embodiment of the present disclosure, where the PVDF is a PVDF (534K) and the lithium salt is LiTFSI, the polymer electrolyte comprises 15 wt % to 55 wt % of the PVDF (534K), 5 wt % to 40 wt % of the CN-PVA, and 40 wt % to 70 wt % of the LiTFSI.

### Prophetic Example 1-38

In prophetic example 1-38, a composite cathode is formed according to an embodiment of the present disclosure. A slurry mixture can be prepared following the method of preparation of a slurry mixture of the polymer electrolyte composite cathode of the present disclosure. A cathode active material, carbon black, and polyvinylidene fluoride binder, and the polymer electrolyte mixture, where the PVDF is a PVDF (534K) is mixed to form a slurry mixture. The slurry is cast onto an aluminum current collector. The organic solvent NMP is evaporated until a dense, dry, and black film remains. The cast slurry mixture is then flattened onto the current collector using a doctor blade to form a cathode film. The cathode film is then calendered to form a composite cathode.

It is reasonably anticipated that a composite cathode can be successfully formed for every composition of the polymer electrolyte mixture that a polymer electrolyte separator layer was formed among the working Examples 1-1 through 1-37.

### Examples 2-1 through 2-37

In Examples 2-1 through 2-37 described below, a series of polymer electrolyte compositions were formed into a polymer electrolyte separator according to various embodiments of the present disclosure, and were tested. PVDF (700K) was used in Examples 2-1 through 2-37 in comparison to PVDF (534K) in Examples 1-1 through 1-37. In some examples, the polymer electrolyte mixtures were successfully formed into polymer electrolyte separator layers and ionic conductivity values at 25° C., 50° C., and 80° C. were measured. In other examples, a polymer electrolyte separator layer could not be formed.

### Example 2-1

In Example 2-1, a polymer electrolyte was prepared using the method for preparation of a polymer electrolyte mixture of the present disclosure. In a first container, a PVDF (700K) was dissolved in an organic solvent NMP. The PVDF (700K) mixture was heated and agitated to promote the dissolution of the PVDF (700K) in the organic solvent. LiTFSI, was dried in a vacuum oven at a temperature of 80° C. to 120° C. for approximately 8 hours to remove moisture. In a second container, a CN-PVA was dissolved in organic solvent to form a mixture. The mixture was then heated and agitated. The dried LiTFSI was added to the CN-PVA mixture until a homogenous mixture was obtained. The homogenous mixture was then mixed with the PVDF (700K) mixture to eventually obtain a mixture of 55 wt % PVDF (700K), 5 wt % CN-PVA, and 40 wt % LiTFSI. The PVDF (700K), CN-PVA, and LiTFSI mixture was then mixed under heat until all components were homogenously distributed.

A polymer electrolyte separator layer was prepared using the method for preparing a solid polymer electrolyte separator with the polymer electrolyte of the present disclosure. The polymer electrolyte mixture was solution cast by means of a dropper. After the polymer electrolyte was solution cast, a film applicator, such as a doctor blade, was used to spread the mixture to form an even layer. The organic solvent in the polymer electrolyte mixture was removed through evaporation over time, eventually solidifying into the polymer electrolyte separator layer.

The polymer electrolyte of Example 2-1 was formed into a mechanically stable polymer electrolyte separator film like the film in FIG. 4A. The ionic conductivity of the polymer electrolyte separator was measured at 25° C., 50° C., and 80° C. The polymer electrolyte separator exhibited ionic conductivity of 7.53×10⁻⁵ S/cm at 25° C., 2.72×10⁻⁴ S/cm at 50° C., and 8.91×10⁻⁴ S/cm at 80° C.

### Example 2-2

In Example 2-2, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 45 wt % PVDF (700K), 5 wt % CN-PVA, and 50 wt % LiTFSI.

A polymer electrolyte separator layer was prepared using the method for preparing a solid polymer electrolyte separator of the present disclosure like in Example 2-1. The polymer electrolyte of Example 2-2 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 2.68×10⁻⁴ S/cm at 25° C., 7.01×10⁻⁴ S/cm at 50° C., and 1.81×10⁻³ S/cm at 80° C.

### Example 2-3

In Example 2-3, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 35 wt % PVDF (700K), 5 wt % CN-PVA, and 60 wt % LiTFSI.

A polymer electrolyte separator layer was also prepared using the method for preparing a solid polymer electrolyte separator of the present disclosure like in Example 2-1. The polymer electrolyte of Example 2-3 was formed a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.43×10⁻⁴ S/cm at 25° C., 1.54×10⁻³ S/cm at 50° C., and 1.81×10⁻³ S/cm at 80° C.

### Example 2-4

In Example 2-4, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 25 wt % PVDF (700K), 5 wt % CN-PVA, and 70 wt % LiTFSI.

A polymer electrolyte separator layer was also prepared using the method for preparing a solid polymer electrolyte separator of the present disclosure like in Example 2-1. The polymer electrolyte of Example 2-4 was formed a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.60×10⁻³ S/cm at 25° C., 3.39×10⁻³ S/cm at 50° C., and 4.21×10⁻³ S/cm at 80° C.

### Example 2-5

In Example 2-5, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 20 wt % PVDF (700K), 5 wt % CN-PVA, and 75 wt % LiTFSI.

A polymer electrolyte separator layer was also prepared using the method for preparing a solid polymer electrolyte separator of the present disclosure like in Example 2-1. The polymer electrolyte of Example 2-5 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 5.36×10⁻⁴ S/cm at 25° C., 9.15×10⁻⁴ S/cm at 50° C., and 1.41×10⁻³ S/cm at 80° C.

### Example 2-6

In Example 2-6, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 5 wt % CN-PVA, and 80 wt % LiTFSI.

A polymer electrolyte separator layer was also prepared using the method for preparing a solid polymer electrolyte separator of the present disclosure like in Example 2-1. The polymer electrolyte of Example 2-6 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 3.06×10⁻⁴ S/cm at 25° C., 4.29×10⁻⁴ S/cm at 50° C., and 4.20×10⁻⁴ S/cm at 80° C.

### Example 2-7

In Example 2-7, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 10 wt % PVDF (700K), 5 wt % CN-PVA, and 85 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-8

In Example 2-8, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 50 wt % PVDF (700K), 10 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-8 was formed a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.33×10⁻⁴ S/cm at 25° C., 9.12×10⁻⁴ S/cm at 50° C., and 1.97×10⁻³ S/cm at 80° C.

### Example 2-9

In Example 2-9, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 40 wt % PVDF (700K), 10 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-9 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 7.11×10⁻⁴ S/cm at 25° C., 1.33×10⁻³ S/cm at 50° C., and 2.38×10⁻³ S/cm at 80° C.

### Example 2-10

In Example 2-10, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 30 wt % PVDF (700K), 10 wt % CN-PVA, and 60 wt % LiTFSI.

A polymer electrolyte separator layer was also prepared using the method for preparing a solid polymer electrolyte separator of the present disclosure like in Example 2-1. The polymer electrolyte of Example 2-10 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.16×10⁻³ S/cm at 25° C., 1.80×10⁻³ S/cm at 50° C., and 3.87×10⁻³ S/cm at 80° C.

### Example 2-11

In Example 2-11, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 20 wt % PVDF (700K), 10 wt % CN-PVA, and 70 wt % LiTFSI.

A polymer electrolyte separator layer was also prepared using the method for preparing a solid polymer electrolyte separator of the present disclosure like in Example 2-1. The polymer electrolyte of Example 2-11 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.55×10⁻³ S/cm at 25° C., 3.14×10⁻³ S/cm at 50° C., and 3.31×10⁻³ S/cm at 80° C.

### Example 2-12

In Example 2-12, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 10 wt % CN-PVA, and 75 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-13

In Example 2-2, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 45 wt % PVDF (700K), 15 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-13 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.11×10⁻³ S/cm at 25° C., 1.93×10⁻³ S/cm at 50° C., and 4.34×10⁻³ S/cm at 80° C.

### Example 2-14

In Example 2-14, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 35 wt % PVDF (534K), 15 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-14 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.45×10⁻³ S/cm at 25° C., 3.18×10⁻³ S/cm at 50° C., and 7.97×10⁻³ S/cm at 80° C.

### Example 2-15

In Example 2-15, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 25 wt % PVDF (700K), 15 wt % CN-PVA, and 60 wt % LiTFSI.

A polymer electrolyte separator layer was also prepared using the method for preparing a solid polymer electrolyte separator of the present disclosure like in Example 2-1. The polymer electrolyte of Example 2-15 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 4.11×10⁻⁴ S/cm at 25° C., 1.55×10⁻³ S/cm at 50° C., and 3.05×10⁻³ S/cm at 80° C.

### Example 2-16

In Example 2-16, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 15 wt % CN-PVA, and 70 wt % LiTFSI.

A polymer electrolyte separator layer was also prepared using the method for preparing a solid polymer electrolyte separator of the present disclosure like in Example 2-1. The polymer electrolyte of Example 2-16 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 4.12×10⁻⁴ S/cm at 25° C., 7.13×10⁻⁴ S/cm at 50° C., and 1.15×10⁻³ S/cm at 80° C.

### Example 2-17

In Example 2-17, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 10 wt % PVDF (700K), 15 wt % CN-PVA, and 75 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-18

In Example 2-18, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 40 wt % PVDF (700K), 20 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-18 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.34×10⁻⁵ S/cm at 25° C., 1.97×10⁻⁴ S/cm at 50° C., and 3.26×10⁻⁴ S/cm at 80° C.

### Example 2-19

In Example 2-19, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 30 wt % PVDF (700K), 20 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-19 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.27×10⁻⁴ S/cm at 25° C., 5.93×10⁻⁴ S/cm at 50° C., and 1.33×10⁻³ S/cm at 80° C.

### Example 2-20

In Example 2-20, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 20 wt % PVDF (700K), 20 wt % CN-PVA, and 60 wt % LiTFSI.

A polymer electrolyte separator layer was also prepared using the method for preparing a solid polymer electrolyte separator of the present disclosure like in Example 2-1. The polymer electrolyte of Example 2-20 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 1.77×10⁻⁴ S/cm at 25° C., 7.34×10⁻⁴ S/cm at 50° C., and 1.60×10⁻³ S/cm at 80° C.

### Example 2-21

In Example 2-21, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 20 wt % CN-PVA, and 65 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-22

In Example 2-22, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 10 wt % PVDF (700K), 20 wt % CN-PVA, and 70 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-23

In Example 2-23, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 35 wt % PVDF (700K), 25 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-23 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 2.40×10⁻⁵ S/cm at 25° C., 1.62×10⁻⁴ S/cm at 50° C., and 7.81×10⁻⁴ S/cm at 80° C.

### Example 2-24

In Example 2-24, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 25 wt % PVDF (700K), 25 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-24 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 3.90×10⁻⁵ S/cm at 25° C., 2.36×10⁻⁴ S/cm at 50° C., and 4.47×10⁻⁴ S/cm at 80° C.

### Example 2-25

In Example 2-25, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 25 wt % CN-PVA, and 60 wt % LiTFSI.

A polymer electrolyte separator layer was also prepared using the method for preparing a solid polymer electrolyte separator of the present disclosure like in Example 2-1. The polymer electrolyte of Example 2-25 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 2.37×10⁻⁴ S/cm at 25° C., 6.03×10⁻⁴ S/cm at 50° C., and 8.46×10⁻⁴ S/cm at 80° C.

### Example 2-26

In Example 2-26, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 10 wt % PVDF (700K), 25 wt % CN-PVA, and 65 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film. A mechanically stable polymer electrolyte separator must not be tacky and must be capable of being shaped into a substantially solid, free-standing membrane. Ionic conductivity values could not be measured.

### Example 2-27

In Example 2-2, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 30 wt % PVDF (700K), 30 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-27 was formed into a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 1.45×10⁻⁴ S/cm at 25° C., 5.14×10⁻⁴ S/cm at 50° C., and 1.37×10⁻³ S/cm at 80° C.

### Example 2-28

In Example 2-28, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 20 wt % PVDF (700K), 30 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-28 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 2.84×10⁻⁴ S/cm at 25° C., 9.76×10⁻⁴ S/cm at 50° C., and 1.62×10⁻³ S/cm at 80° C.

### Example 2-29

In Example 2-29, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 30 wt % CN-PVA, and 55 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-30

In Example 2-30, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 25 wt % PVDF (700K), 35 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-30 was formed into a mechanically stable a mechanically stable polymer electrolyte separator film like the film in FIG. 4A. The ionic conductivity of the polymer electrolyte separator film was measured at 25° C., 50° C., and 80° C. The polymer electrolyte separator exhibited ionic conductivity of 2.04×10⁻⁴ S/cm at 25° C., 4.35×10⁻⁴ S/cm at 50° C., and 9.82×10⁻⁴ S/cm at 80° C.

### Example 2-31

In Example 2-31, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 35 wt % CN-PVA, and 50 wt % LiTFSI.

A polymer electrolyte separator layer was also prepared using the method for preparing a solid polymer electrolyte separator of the present disclosure like in Example 2-1. The polymer electrolyte of Example 2-31 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 4.34×10⁻⁵ S/cm at 25° C., 2.62×10⁻⁴ S/cm at 50° C., and 6.85×10⁻⁴ S/cm at 80° C.

### Example 2-32

In Example 2-32, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 10 wt % PVDF (700K), 35 wt % CN-PVA, and 55 wt % LiTFSI.

An attempt was also made to prepare a polymer electrolyte separator layer using the method for preparing a solid polymer electrolyte separator of the present disclosure like in Example 2-1. The composition could not be formed into a mechanically stable polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Example 2-33

In Example 2-33, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 20 wt % PVDF (700K), 40 wt % CN-PVA, and 40 wt % LiTFSI.

A polymer electrolyte separator layer was also prepared using the method for preparing a solid polymer electrolyte separator of the present disclosure like in Example 2-1. The polymer electrolyte of Example 2-33 was formed into a mechanically stable polymer electrolyte separator film having some elasticity like the film in FIG. 4B. The ionic conductivity of the polymer electrolyte separator film was measured at 25° C., 50° C., and 80° C. The polymer electrolyte separator exhibited ionic conductivity of 8.40×10⁻⁶ S/cm at 25° C., 6.97×10⁻⁵ S/cm at 50° C., and 2.25×10⁻⁴ S/cm at 80° C.

### Example 2-34

In Example 2-34, a polymer electrolyte mixture was also prepared using the method for preparation of a polymer electrolyte mixture of the present disclosure like in Example 2-1. PVDF (700K) was used as the polymer host, LiTFSI was used as the lithium salt, and CN-PVA was used as the polymer blend. The polymer electrolyte mixture was comprised of 15 wt % PVDF (700K), 40 wt % CN-PVA, and 45 wt % LiTFSI.

An attempt was also made to prepare a polymer electrolyte separator layer using the method for preparing a solid polymer electrolyte separator of the present disclosure like in Example 2-1. The composition could not be formed into polymer electrolyte separator film like the film in FIG. 4C. A mechanically stable polymer electrolyte separator must not be tacky and must be capable of being shaped into a substantially solid, free-standing membrane. Ionic conductivity values could not be measured.

### Examples 2-35, 2-36, and 2-37

In Examples 2-35, 2-36, and 2-37, polymer electrolyte mixtures were also prepared using the method for preparation of a polymer electrolyte mixture of the present disclosure like in Example 2-1. The polymer electrolyte mixture of Example 2-35 was comprised of 15 wt % PVDF (700K), 45 wt % CN-PVA, and 40 wt % LiTFSI. The polymer electrolyte mixture of Example 2-36 was comprised of 10 wt % PVDF (700K), 45 wt % CN-PVA, and 45 wt % LiTFSI. The polymer electrolyte mixture of Example 2-37 was comprised of 5 wt % PVDF (700K), 45 wt % CN-PVA, and 50 wt % LiTFSI.

In Examples 2-35, 2-36, and 2-37, attempts were also made to prepare polymer electrolyte separator layers using the method for preparing a solid polymer electrolyte separator of the present disclosure like in Example 2-1. The compositions could not be formed into mechanically stable polymer electrolyte separator films.

TABLE 3
Summary of Working Examples 2-1 through 2-37

| Working | PVDF (700K) | CN-PVA | Lithium Salt | Ionic Conductivity (S/cm) | | |
|---|---|---|---|---|---|---|
| Example | (wt %) | (wt %) | LiTFSI (wt %) | 25 C. ° | 50 C. ° | 80 C. ° |
| 2-1 | 55 | 5 | 40 | 7.53 × 10⁻⁵ | 2.72 × 10⁻⁴ | 8.91 × 10⁻⁴ |
| 2-2 | 45 | | 50 | 2.68 × 10⁻⁴ | 7.01 × 10⁻⁴ | 1.81 × 10⁻³ |
| 2-3 | 35 | | 60 | 3.43 × 10⁻⁴ | 1.54 × 10⁻³ | 1.81 × 10⁻³ |
| 2-4 | 25 | | 70 | 1.60 × 10⁻³ | 3.39 × 10⁻³ | 4.21 × 10⁻³ |
| 2-5 | 20 | | 75 | 5.36 × 10⁻⁴ | 9.15 × 10⁻⁴ | 1.41 × 10⁻³ |
| 2-6 | 15 | | 80 | 3.06 × 10⁻⁴ | 4.29 × 10⁻⁴ | 4.20 × 10⁻⁴ |
| 2-7 | 10 | | 85 | Could not form free-standing membrane | | |
| 2-8 | 50 | 10 | 40 | 3.33 × 10⁻⁴ | 9.12 × 10⁻⁴ | 1.97 × 10⁻³ |
| 2-9 | 40 | | 50 | 7.11 × 10⁻⁴ | 1.33 × 10⁻³ | 2.38 × 10⁻³ |
| 2-10 | 30 | | 60 | 1.16 × 10⁻³ | 1.80 × 10⁻³ | 3.87 × 10⁻³ |
| 2-11 | 20 | | 70 | 1.55 × 10⁻³ | 3.14 × 10⁻³ | 3.31 × 10⁻³ |
| 2-12 | 15 | | 75 | Could not form free-standing membrane | | |
| 2-13 | 45 | 15 | 40 | 1.11 × 10⁻³ | 1.93 × 10⁻³ | 4.34 × 10⁻³ |
| 2-14 | 35 | | 50 | 1.45 × 10⁻³ | 3.18 × 10⁻³ | 7.97 × 10⁻³ |
| 2-15 | 25 | | 60 | 4.11 × 10⁻⁴ | 1.55 × 10⁻³ | 3.05 × 10⁻³ |
| 2-16 | 15 | | 70 | 4.12 × 10⁻⁴ | 7.13 × 10⁻⁴ | 1.15 × 10⁻³ |
| 2-17 | 10 | | 75 | Could not form free-standing membrane | | |
| 2-18 | 40 | 20 | 40 | 3.34 × 10⁻⁵ | 1.97 × 10⁻⁴ | 3.26 × 10⁻⁴ |
| 2-19 | 30 | | 50 | 1.27 × 10⁻⁴ | 5.93 × 10⁻⁴ | 1.33 × 10⁻³ |
| 2-20 | 20 | | 60 | 1.77 × 10⁻⁴ | 7.34 × 10⁻⁴ | 1.60 × 10⁻³ |
| 2-21 | 15 | | 65 | Could not form free-standing membrane | | |
| 2-22 | 10 | | 70 | Could not form free-standing membrane | | |
| 2-23 | 35 | 25 | 40 | 2.40 × 10⁻⁵ | 1.62 × 10⁻⁴ | 7.81 × 10⁻⁴ |
| 2-24 | 25 | | 50 | 3.90 × 10⁻⁵ | 2.36 × 10⁻⁴ | 4.47 × 10⁻⁴ |
| 2-25 | 15 | | 60 | 2.37 × 10⁻⁴ | 6.03 × 10⁻⁴ | 8.46 × 10⁻⁴ |
| 2-26 | 10 | | 65 | Could not form free-standing membrane | | |
| 2-27 | 30 | 30 | 40 | 1.45 × 10⁻⁴ | 5.14 × 10⁻⁴ | 1.37 × 10⁻³ |
| 2-28 | 20 | | 50 | 2.84 × 10⁻⁴ | 9.76 × 10⁻⁴ | 1.62 × 10⁻³ |
| 2-29 | 15 | | 55 | Could not form free-standing membrane | | |
| 2-30 | 25 | 35 | 40 | 2.04 × 10⁻⁴ | 4.35 × 10⁻⁴ | 9.82 × 10⁻⁴ |
| 2-31 | 15 | | 50 | 4.34 × 10⁻⁵ | 2.62 × 10⁻⁴ | 6.85 × 10⁻⁴ |
| 2-32 | 10 | | 55 | Could not form free-standing membrane | | |
| 2-33 | 20 | 40 | 40 | 8.40 × 10⁻⁶ | 6.97 × 10⁻⁵ | 2.25 × 10⁻⁴ |

| | | | | |
|---|---|---|---|---|
| 2-34 | 15 | | 45 | Could not form free-standing membrane |
| 2-35 | 15 | 45 | 40 | Could not form free-standing membrane |
| 2-36 | 10 | | 45 | Could not form free-standing membrane |
| 2-37 | 5 | | 50 | Could not form free-standing membrane |

The working Examples 2-1 through 2-37 demonstrate the compositions of PVDF (700K), CN-PVA, and lithium salt that form a free-standing membrane and meet the required ionic conductivity threshold for technical and commercial viability. First, Examples 2-1 through 2-37 together demonstrate the levels of CN-PVA at which a free-standing membrane with the required ionic conductivity is formed. Examples 2-1 through 2-6 demonstrate that minimum level of 5 wt % CN-PVA is required; Examples 2-30 and 2-31 demonstrate that a maximum level of 35 wt % CN-PVA can be used. Examples 2-35 through 2-37 demonstrate that when CN-PVA is at 45 wt %, no free-standing membrane can be formed with any combination of PVDF (700K) and LiTFSI. Example 2-33 demonstrates that although at the 40 wt % CN-PVA level a free standing membrane can be formed, the ionic conductivity does not meet the required threshold. A person of ordinary skill in the art would also understand that from Examples 2-1 through 2-37, taken together, that at no levels of CN-PVA at 45 wt % and above, a free-standing membrane can be formed.

Second, Examples 2-1 through 2-37 together demonstrate that at least a range of 15 wt % to 55 wt % PVDF (700K) can be used, given the useable levels of CN-PVA between 5-35 wt %. Examples 2-6, 2-16, 2-25, and 2-31 support the use of as low as 15 wt % PVDF (700K). Example 2-1 supports the use of much as 55 wt % PVDF (700K). A person of ordinary skill in the art would also understand that in the polymer electrolyte of the present disclosure, as a PiSE system, a polymer content of 60 wt % (55 wt % PVDF (700K) and 5 wt % CN-PVA) should not be exceeded to maintain a 40 wt % lithium salt content.

Third, Examples 2-1 through 2-37 together demonstrate that at least a range of 40 wt % to 80 wt % LiTFSI can be used, given the useable levels of CN-PVA between 5-35 wt %. Examples 2-1, 2-8, 2-13, 2-18, 2-23, 2-27, and 2-30 support the use of as low as 40 wt % LiTFSI. Example 2-6 supports the use of as much as 80 wt % LiTFSI.

Thus, according to one embodiment of the present disclosure, where the PVDF is a PVDF (700K) and the lithium salt is LiTFSI, the polymer electrolyte comprises 15 wt % to 55 wt % of the PVDF (700K), 5 wt % to 35 wt % of the CN-PVA, and 40 wt % to 80 wt % of the LiTFSI.

### Prophetic Example 2-38

In prophetic example 2-38, a composite cathode is formed according to an embodiment of the present disclosure. A slurry mixture can be prepared following the method of preparation of a slurry mixture of the polymer electrolyte composite cathode of the present disclosure. A cathode active material, carbon black, and polyvinylidene fluoride binder, and the polymer electrolyte mixture, where the PVDF is a PVDF (700K), is mixed to form a slurry mixture. The slurry is cast onto an aluminum current collector. The organic solvent NMP is evaporated until a dense, dry, and black film remains. The cast slurry mixture is then flattened onto the current collector using a doctor blade to form a cathode film. The cathode film is then calendered to form a composite cathode.

It is reasonably anticipated that a composite cathode can be successfully formed for every composition of the polymer electrolyte mixture that a polymer electrolyte separator layer was formed among the working Examples 2-1 through 2-37.

### Example 3

In Examples 3-1, 3-2, 3-3, and 3-4 described below, a series of working examples of the polymer electrolyte according to various embodiments of the present disclosure were formulated into a composite cathode and a polymer electrolyte separator and were then integrated into a rechargeable battery cell, and tested.

### Example 3-1 LFP Coin Cell

In Example 3-1 a polymer electrolyte mixture was also prepared using the method for preparation of a polymer electrolyte mixture of the present disclosure. A PVDF (534K) at 25 wt %, a CN-PVA polymer blend at 10 wt %, and a LiTFSI at 65 wt % was used for the polymer electrolyte mixture.

A slurry and a composite cathode were also prepared following the method of preparation of a slurry mixture of the polymer electrolyte composite cathode of the present disclosure. The cathode active material used for the composite cathode was lithium iron phosphate (LFP). A polymer electrolyte mixture was also prepared using the method for preparing a polymer electrolyte mixture of the present disclosure. The polymer electrolyte separator was then dissolved in NMP and solution cast on the LFP based composite cathode formed earlier. The AN was evaporated by placing the film into a small antechamber in the glovebox and inducing a slight vacuum. The process was repeated twice to ensure a dense and uniform film deposit on the LFP based composite cathode. After that, a thick Li-metal (500 μm) was placed on top and together with the LFP composite cathode with formed polymer electrolyte layer was assembled into a coin cell. The LFP composite cathode, polymer electrolyte layer, and lithium metal stack were 16 mm in diameter.

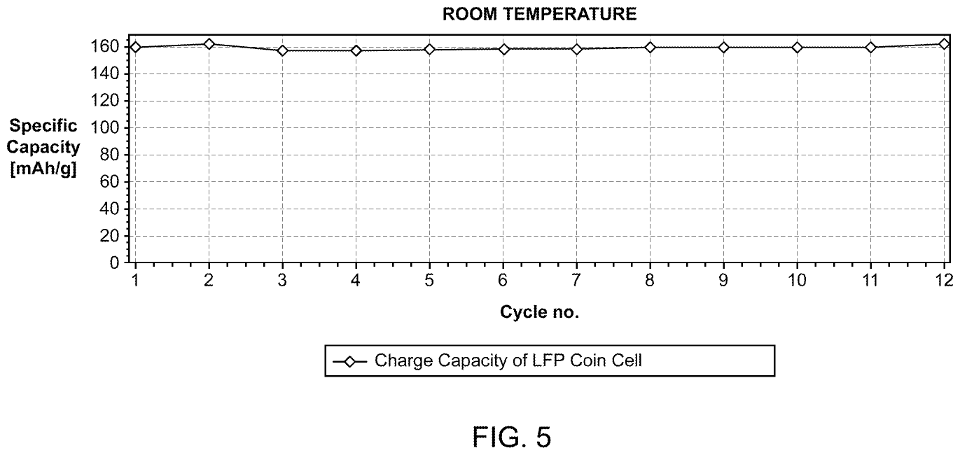

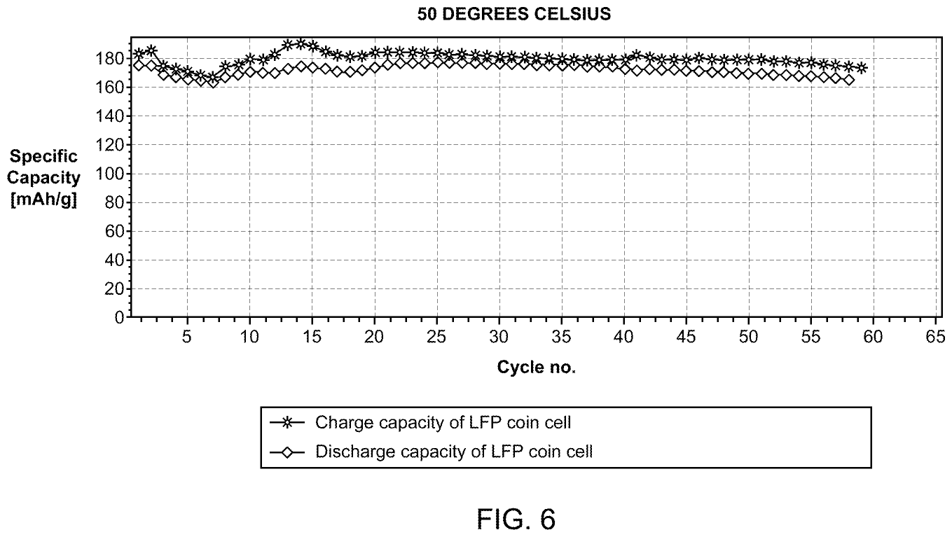

The coin cell was discharged for 12 cycles at 25° C. and 50° C. FIG. 5 shows the specific capacity of the coin cell discharged for the 12 cycles at 25° C. FIG. 6 shows the specific capacity of the coin cell discharged for more than 50 cycles at 50° C.

### Prophetic Example 3-2 (LFP Coin Cell with Dry Placement)

In Example 3-2, the steps for preparing a slurry mixture and a composite cathode are repeated. Like working Example 3-1, a lithium iron phosphate (LFP) cathode active material can be used for the composite cathode. Like Example 3-1, a polymer electrolyte mixture is also prepared using the method for preparing a polymer electrolyte mixture of the present disclosure. But different from Example 3-1, the polymer electrolyte is cast into a Teflon evaporation dish and the solvent is evaporated. Once evaporated, a polymer electrolyte free-standing membrane will be formed, peeled from the dish, and shaped into circular disks having 16 mm in diameter for a coin cell. The circular disk is then dry placed onto the composite cathode. A thick Li-metal (500 μm) will then be placed on top of the circular disk. The composite cathode, polymer electrolyte separator layer, and lithium metal anode layer are then finally assembled into a coin cell.

### Prophetic Example 3-3 (LFP with Pouch Cell)

In Example 3-3, the steps for preparing a slurry mixture and a composite cathode are repeated. Like working Example 3-1, the cathode active material used for the composite cathode is lithium iron phosphate (LFP). Like Example 3-1, a polymer electrolyte mixture is also prepared using the method for preparing a polymer electrolyte mixture of the present disclosure identical. But different from Example 3-1, the composite cathode, polymer electrolyte separator layer, and lithium metal anode layer will be shaped in a format suitable for a pouch cell. The polymer electrolyte mixture is cast into a Teflon evaporation dish and the solvent is evaporated to form a polymer electrolyte layer. The Teflon evaporation dish is of a size suitable to form a quadrilateral and in this example a 50 mm×50 mm square polymer electrolyte layer is formed. A composite cathode and a lithium metal anode each 50 mm×50 mm are similarly formed.

The composite cathode, polymer electrolyte layer, and lithium metal anode are assembled into a pouch cell using the method for assembly a pouch cell of the present disclosure. A lead tab, which can be made of nickel, is welded to the composite cathode and polymer electrolyte layer piece. The lithium metal anode piece, cut earlier dimensionally to be the same as the composite cathode and the polymer electrolyte layer are layered together to form a unit cell. The unit cell is inserted between two plastic inserts to provide mechanical rigidity. Additionally, an insulating material, which can be made of polyolefin, is wrapped around the entire unit cell and plastic insert assembly. This assembly is then inserted into a heat sealing foil and sealed to form the lithium-ion battery pouch cell.

What is claimed is:

1. A polymer electrolyte, comprising:
a polyvinylidene fluoride (PVDF);
a lithium salt; and
a cyanoethyl polyvinyl alcohol (CN-PVA),
the PVDF, the lithium salt, and the CN-PVA formed into a free-standing membrane.

2. The polymer electrolyte of claim 1, wherein the PVDF is a PVDF (534K), the lithium salt is lithium bis(trifluoromethanesulfonyl)imide (LiTFSI), and the polymer electrolyte comprises 15 wt % to 55 wt % of the PVDF (534K), 5 wt % to 40 wt % of the CN-PVA, and 40 wt % to 70 wt % of the LiTFSI.

3. The polymer electrolyte of claim 1, wherein the PVDF is a PVDF (700K), the lithium salt is lithium bis(trifluoromethanesulfonyl)imide (LiTFSI), and the polymer electrolyte comprises 15 wt % to 55 wt % of the PVDF (700K), 5 wt % to 35 wt % of the CN-PVA, and 40 wt % to 80 wt % of the LiTFSI.

4. The polymer electrolyte of claim 1, wherein the polymer electrolyte has an ionic conductivity greater than 1×10⁻⁵ S/cm at a temperature greater than or equal to 25° C.

5. A method of manufacturing the polymer electrolyte of claim 1, comprising:
dissolving the PVDF in a first organic solvent;
dissolving the CN-PVA in a second organic solvent;
dissolving the lithium salt in the second organic solvent;
adding the second organic solvent containing the lithium salt and the CN-PVA to the first organic solvent containing the PVDF to form a mixture; and
heating the mixture under heat to obtain a homogeneous mixture.

6. A composite cathode for a rechargeable battery cell, comprising:
a cathode active material;
a carbon-containing material;
the polymer electrolyte of claim 1; and
a PVDF binder binding the cathode active material, the carbon-containing material, and the polymer electrolyte,
wherein the cathode active material, the carbon-containing material, the PVDF binder, and the polymer electrolyte are formed as a cathode film; and
wherein the cathode film is formed on a current collector.

7. The composite cathode of claim 6, wherein the polymer electrolyte functions as a catholyte.

8. The composite cathode of claim 6, wherein the cathode active material is a lithium iron phosphate.

9. A polymer electrolyte separator for a rechargeable battery cell, the polymer electrolyte separator comprising the polymer electrolyte of claim 1, wherein the polymer electrolyte is formed as a solid layer, the solid layer immediately adjacent a cathode layer and an anode layer of the rechargeable battery cell.

10. The polymer electrolyte separator of claim 9, wherein the solid layer is formed by dry placing the solid layer between the cathode layer and the anode layer.

11. A method for manufacturing a composite cathode for a rechargeable battery cell, comprising:
preparing the polymer electrolyte according to the method of claim 5;
mixing the polymer electrolyte with a cathode active material, a carbon-containing material, and a PVDF binder to form a slurry mixture;
casting the slurry mixture on a current collector;
spreading the slurry mixture on the current collector;
removing the solvent in the slurry mixture to form a cathode film layer; and
calendering the cathode film layer and the current collector.

12. The method of claim 11, wherein the cathode film layer and the current collector are calendered to increase the density of the cathode film layer to 1.7 g/cm³.

13. A method of manufacturing an electrode stack, comprising:
preparing a first portion and a second portion of the polymer electrolyte according to the method of claim 5;
forming a composite cathode by
mixing the first portion of the polymer electrolyte with a cathode active material, a carbon-containing material, and a polyvinylidene difluoride binder to form a slurry mixture;
casting the slurry mixture on a current collector;
spreading the slurry mixture on the current collector;
removing the solvent in the slurry mixture to form a cathode film layer; and
calendering the cathode film layer and the current collector;
forming the second portion of the polymer electrolyte on the composite cathode as a separator layer;
forming an anode layer on a negative current collector; and
stacking the anode layer and the negative current collector on the separator layer,
wherein the separator layer is dry placed on the composite cathode.

14. A rechargeable battery cell comprising:
the composite cathode of claim 6 formed as a cathode layer on a first current collector to form a positive electrode;
an anode layer formed on a second current collector to form a negative electrode, wherein the anode layer is a lithium metal; and
a polymer electrolyte separator comprising the polymer electrolyte,
wherein the polymer electrolyte separator is immediately adjacent the cathode layer and the anode layer, and
wherein the cathode layer, the anode layer, and the polymer electrolyte separator are solid.

15. The rechargeable battery cell of claim 14, wherein the cathode active material in the composite cathode is a lithium iron phosphate.
